(19) United States
(12) Patent Application Publication
(10) Pub. No.: US 2021/0173493 A1
(43) Pub. Date: Jun. 10, 2021

(54) METHOD AND APPARATUS CONFIGURED TO MANAGE DRAFT MESSAGING COMMUNICATIONS AND DRAFT MESSAGE INTERFACES IN A GROUP-BASED COMMUNICATION SYSTEM

(71) Applicant: SLACK TECHNOLOGIES, INC., San Francisco, CA (US)

(72) Inventors: Ittai Sean BARZILAY, San Francisco, CA (US); Ana Cecilia MARTINEZ CURRIELCHE, Alameda, CA (US); Wayne FAN, San Francisco, CA (US); Christopher David MONTROIS, Louisville, CO (US); Jordan WILLIAMS, San Francisco, CA (US)

(73) Assignee: SLACK TECHNOLOGIES, INC., San Francisco, CA (US)

(21) Appl. No.: 16/703,708

(22) Filed: Dec. 4, 2019

(51) Int. Cl. G06F 3/023; G06F 3/0482; H04L 12/58; G06F 16/9536

(52) U.S. Cl. CPC G06F 3/0237; G06F 3/0482; G06F 16/9536; H04L 51/16; H04L 51/28

(57) ABSTRACT

Various embodiments of the present invention are directed to an improved group-based communication apparatus that is configured to manage draft messaging communications and various interfaces associated with such draft messaging communications in a group-based communication system. The group-based communication apparatus is configured to render a draft message composer interface to a group-based communication interface to provide an interface for a user to compose a draft messaging communication, including indicating a destination and/or content to be included in such draft messaging communication. The group-based communication apparatus is further configured to detect engagement of interface components and assign draft message titles to draft messaging communications. The assigned draft message titles, or draft message placeholders when no draft message title is assigned, may be displayed to a sidebar pane of the group-based communication interface.

### BACKGROUND

Various messaging systems may support draft messaging communications and associated interfaces for managing such draft messaging communications. Applicant has identified a number of deficiencies and problems associated with such conventional messaging systems. Through applied effort, ingenuity, and innovation, these deficiencies and problems have been solved by developing solutions that are structured in accordance with the embodiments of the present invention, many examples of which are described in detail herein.

### BRIEF SUMMARY

Various embodiments of the present invention are directed to an improved group-based communication apparatus that is configured to manage draft messaging communications and associated draft message interfaces in a group-based communication system. The group-based communication apparatus is configured to render a draft message composer interface to a group-based communication interface to provide an interface for a user to compose a draft messaging communication, including indicating a destination and/or content to be included in such draft messaging communication. The group-based communication apparatus is further configured to detect engagement of the interface or its components, determine and render destination suggestions to the user based on various factors, as well as assign draft message titles to draft messaging communications as discussed in detail herein. The assigned draft message titles, or draft message placeholders when no such draft message title is assigned, further may be rendered to a sidebar pane of the group-based communication interface. The group-based communication apparatus is further configured to render a drafts view interface to a group-based communication interface to provide an interface for a user to view and access all draft messaging communications associated with the user identifier.

One embodiment is directed to a group-based communication apparatus configured to manage a draft message composer interface of a group-based communication system, the group-based communication apparatus comprising at least one processor and at least one memory, the at least one memory having computer-coded instructions therein, wherein the computer-coded instructions are configured to, in execution with the at least one processor, cause the group-based communication apparatus to: cause rendering of a draft message composer interface to a group-based communication interface of the group-based communication system in response to receiving a compose draft message request comprising a user identifier, wherein the draft message composer interface comprises a destination input component; in response to detecting a non-keystroke engagement of the destination input component, determine a first destination suggestions set by querying a group-based communication suggestions repository based upon at least the user identifier; and cause rendering of a destination suggestion interface comprising the first destination suggestions set. In another embodiment, the computer-coded instructions are further configured to cause the group-based communication apparatus to receive user entry of a first destination input in the destination input component such that one or more keystroke entries are received in the destination input component.

In some embodiments, the draft message composer interface further comprises an attach object component.

In one embodiment, the computer-coded instructions are further configured to cause the group-based communication apparatus to: detect a first keystroke engagement of the destination input component; determine a second destination suggestions set by querying the group-based communication suggestions repository based upon at least the user identifier and the detected first keystroke engagement; and automatically update the destination suggestion interface to replace the first destination suggestions set with the second destination suggestions set. In further embodiments, the detected first keystroke engagement of the destination input component comprises a group-based communication channel indicator and the second destination suggestions set comprises one or more suggested group-based communication channels. In still further embodiments, the group-based communication channel indicator comprises a keystroke entry of a hashtag.

In another embodiment, the group-based communication suggestions repository comprises user recipient data, group-based communication thread data, and group-based communication channel data.

In some embodiments, the first destination suggestions set comprises one or more suggested user recipients, one or more suggested group-based communication threads, one or more suggested group-based communication channels, or combinations thereof.

In another embodiment, the destination suggestion interface is configured for user selection engagement, and wherein a first destination selection indication is generated upon user selection engagement of at least one destination suggestion item of the first destination suggestions set. In further embodiments, the computer-coded instructions are further configured to cause the group-based communication apparatus to: in response to generating a first destination selection indication upon user selection engagement of at least one destination suggestion item, determine whether the first destination selection indication corresponds to a group-based communication channel, a group-based communication thread, or one or more user recipients; and in an instance where the first destination selection indication corresponds to a selected group-based communication channel, cause rendering in the destination input component of a channel title tile associated with the selected group-based communication channel. In some embodiments, the channel title tile comprises a user engageable deletion element and the computer-coded instructions are further configured to stop rendering the channel title tile to the destination input component upon detection of a user selection engagement of the user engageable deletion element. In still further embodiments, the computer-coded instructions are further configured to cause the group-based communication apparatus to configure the destination input component to prevent keystroke engagement of the destination input component. In alternative embodiments, the computer-coded instructions are further configured to cause the group-based communication apparatus to configure the destination input component to facilitate a keystroke engagement of the destination input component corresponding to one or more additional group-based communication channels; and in response to receipt of one or more keystrokes corresponding to one or more additional group-based communication channels, cause rendering of an alert message to the draft message composer interface.

In other embodiments, wherein the first destination selection indication corresponds to a selected group-based communication channel wherein the computer-coded instructions are further configured to cause the group-based communication apparatus to: determine whether the user profile associated with the user identifier is a member of the selected group-based communication channel; and in an instance where the user profile associated with the user identifier is not a member of the selected group-based communication channel, cause rendering of an alert message to the draft message composer interface. In further embodiments, determining whether the user profile associated with the user identifier is a member of the selected group-based communication channel comprises comparing the user identifier to a channel membership directory associated with the selected group-based communication channel. In still further embodiments, the computer-coded instructions are further configured to cause the group-based communication apparatus to, in an instance where the user profile associated with the user identifier is a member of the selected group-based communication channel, determine whether the user profile associated with the user identifier has write access privileges to the selected group-based communication channel; and in an instance where the user profile associated with the user identifier has write access privileges to the selected group-based communication channel, cause rendering in the destination input component of a channel title tile associated with the selected group-based communication channel. In further embodiments, the computer-coded instructions are further configured to cause the group-based communication apparatus to configure the destination input component to prevent keystroke engagement of the destination input component. In other embodiments, the channel title tile comprises a user engageable deletion element and the computer-coded instructions are further configured to stop rendering the channel title tile to the destination input component upon detection of a user selection engagement of the user engageable deletion element. In still further embodiments, the computer-coded instructions are further configured to cause the group-based communication apparatus to in an instance where the user profile associated with the user identifier does not have write access privileges to the selected group-based communication channel, cause rendering of an error indication to the draft message composer interface.

In some embodiments, the computer-coded instructions are further configured to cause the group-based communication apparatus to, in an instance where the first destination selection indication corresponds to a selected group-based communication thread, cause rendering in the destination input component of a thread title tile associated with the selected group-based communication thread. In further embodiments, the computer-coded instructions are further configured to cause the group-based communication apparatus to configure the destination input component to prevent keystroke engagement of the destination input component. In alternative embodiments, the thread title tile comprises a user engageable deletion element and the computer-coded instructions are further configured to stop rendering the thread title tile to the destination input component upon detection of a user selection engagement of the user engageable deletion element.

In still other embodiments, the computer-coded instructions are further configured to cause the group-based communication apparatus to: in an instance where the first destination selection indication corresponds to one or more selected user recipients, cause rendering in the destination input component of a user identifier tile associated with each user recipient of the one or more selected user recipients; configure the destination input component to facilitate a keystroke engagement of the destination input component corresponding to one or more additional selected user recipients; determine an additional user recipient suggestions set; and automatically update the destination suggestion interface to replace the first destination suggestions set with the additional user recipient suggestions set. In some embodiments, determining the additional user recipient suggestions set is based upon at least the user identifier associated with the compose draft message request and the first destination selection indication. In further embodiments, each user identifier tile comprises a user engageable deletion element and the computer-coded instructions are further configured to stop rendering at least one of the user identifier tiles to the destination input component upon detection of a user selection engagement of at least one of the user engageable deletion elements.

In some embodiments, determining the first destination suggestions set by querying the group-based communication suggestions repository based upon at least the user identifier comprises: querying the group-based communication suggestions repository for destination suggestion items; retrieving user profile data associated with the user identifier from the group-based communication suggestions repository; ranking the destination suggestion items returned by the query based on the retrieved user profile data; and determining the first destination suggestions set based on the ranking of the destination suggestion items. In further embodiments, the user profile data stored in the group-based communication suggestions repository comprises at least one of user role data, user organization data, user topic data, historical channel interaction data, historical thread interaction data, historical user interaction data, or combinations thereof. In some embodiments, the first destination suggestions set is determined by comparing the ranking of the destination suggestion items to a predetermined threshold.

In some embodiments, the compose draft message request further comprises a current group identifier associated with the group-based communication interface and the retrieved user profile data comprises one or more additional group identifiers associated with the user identifier. In further embodiments, the destination suggestion items returned by the query comprise one or more destination suggestion items associated with the current group identifier. In still further embodiments, the destination suggestion items returned by the query comprise one or more destination suggestion items associated with the one or more additional group identifiers.

In some embodiments, determining the first destination suggestions set by querying the group-based communication suggestions repository based upon at least the user identifier comprises: querying the group-based communication suggestions repository for destination suggestion items; retrieving user profile data associated with the user identifier from the group-based communication suggestions repository; ranking destination suggestion items returned by the query based on the retrieved user profile data; and determining the first destination suggestions set based on the ranking of the destination suggestion items. In further embodiments, determining a second destination suggestions set by querying the group-based communication suggestions repository based upon at least the user identifier and the detected first keystroke engagement comprises: updating the ranking of the destination suggestion items based on the retrieved user profile data and the detected first keystroke engagement to define the second destination suggestions set.

In other embodiments, the detected first keystroke engagement of the destination input component comprises a group-based communication thread indicator and the first destination suggestions set comprises one or more suggested group-based communication threads. In still other embodiments, the detected first keystroke engagement of the destination input component comprises an user recipient indicator and the first destination suggestions set comprises one or more suggested user recipients.

Still other embodiments are directed to a group-based communication apparatus configured to manage a drafts view interface of a group-based communication system, the group-based communication apparatus comprising at least one processor and at least one memory, the at least one memory having computer-coded instructions therein, wherein the computer-coded instructions are configured to, in execution with the at least one processor, cause the group-based communication apparatus to, in response to receiving a drafts view request comprising a user identifier, query a group-based communication drafts repository for all draft messaging communications associated with the user identifier; and cause rendering to a drafts view interface of all draft messaging communications returned by the query. In a further embodiment, each of the draft messaging communications returned by the query comprises an author identifier matching the user identifier.

In another embodiment, each of the draft messaging communications comprises a draft message title and the computer-coded instructions are further configured to cause the group-based communication apparatus to cause ordering of the draft messaging communications within the drafts view interface based on the draft message titles of the draft messaging communications.

In still other embodiments, each of the draft messaging communications comprises a last edit timestamp and the computer-coded instructions are further configured to cause the group-based communication apparatus to cause ordering of the draft messaging communications within the drafts view interface based on the last edit timestamps of the draft messaging communications. In still other embodiments, each draft messaging communication comprises a user engageable link configured to allow access to the draft messaging communication upon user selection engagement of the user engageable link.

In further embodiments, the computer-coded instructions are further configured to cause the group-based communication apparatus to, in response to detecting user selection engagement of the user engageable link, cause rendering of the selected draft messaging communication in a draft message composer interface. In other embodiments, the computer-coded instructions are further configured to cause the group-based communication apparatus to, in response to detecting user selection engagement of the user engageable link, cause rendering of the selected draft messaging communication in a group-based communication channel interface. In another embodiment, the computer-coded instructions are further configured to cause the group-based communication apparatus to, in response to detecting user selection engagement of the user engageable link, cause rendering of the selected draft messaging communication in a group-based communication thread interface. In still further embodiments, the computer-coded instructions are further configured to cause the group-based communication apparatus to, in response to detecting user selection engagement of the user engageable link, cause rendering of the selected draft messaging communication in a direct message interface.

Still other embodiments are directed to a group-based communication apparatus configured to manage a group-based communication interface of a group-based communication system, the group- based communication apparatus comprising at least one processor and at least one memory, the at least one memory having computer-coded instructions therein, wherein the computer-coded instructions are configured to, in execution with the at least one processor, cause the group-based communication apparatus to, cause rendering of a draft message composer interface to the group-based communication interface of the group-based communication system in response to receiving a compose draft message request comprising a user identifier, wherein the draft message composer interface is associated with a draft messaging communication; and cause rendering of a draft message placeholder in a sidebar pane of the group-based communication interface, wherein the draft message placeholder is associated with the draft messaging communication. In further embodiments, the computer-coded instructions are further configured to cause the group-based communication apparatus to: assign a draft message title to the draft messaging communication; and automatically update the sidebar pane of the group-based communication interface to replace the draft message placeholder with the assigned draft message title. In still further embodiments, the draft message composer interface comprises a destination input component and a draft content input component.

In still further embodiments, assigning the draft message title to the draft messaging communication comprises detecting a keystroke engagement of the draft content input component and assigning at least a portion of the detected keystroke engagement as the draft message title of the draft messaging communication. In further embodiments, the draft messaging communication comprises the detected keystroke engagement, an author identifier corresponding to the user identifier, and the draft message title.

In alternative embodiments, assigning the draft message title to the draft messaging communication comprises detecting a keystroke engagement of the destination input component and assigning at least a portion of the detected keystroke engagement as the draft message title of the draft messaging communication. In further embodiments, the draft messaging communication comprises the detected keystroke engagement, an author identifier corresponding to the user identifier, and the draft message title.

In another embodiment, the draft message placeholder in the sidebar pane comprises a user engageable link configured to allow access to the draft messaging communication upon user selection engagement of the user engageable link. In other embodiments, the draft message title in the sidebar pane comprises a user engageable link configured to allow access to the draft messaging communication upon user selection engagement of the user engageable link.

In still other embodiments, the sidebar pane comprises a plurality of draft message placeholders and a plurality of draft message titles associated with a plurality of draft messaging communications. In further embodiments, each of the plurality of draft messaging communications comprises a last edit timestamp and wherein the computer-coded instructions are further configured to cause the group-based communication apparatus to: cause ordering of the draft messaging communications within the sidebar pane based on the last edit timestamps of the draft messaging communications.

Still other embodiments are directed to a group-based communication apparatus configured to manage a group-based communication interface of a group-based communication system, the group-based communication apparatus comprising at least one processor and at least one memory, the at least one memory having computer-coded instructions therein, wherein the computer-coded instructions are configured to, in execution with the at least one processor, cause the group-based communication apparatus to: render a plurality of panes to the group-based communication interface, wherein the plurality of panes are configured to be viewable simultaneously within a defined window display of the group-based communication interface and wherein the plurality of panes includes a first pane; render a compose interface element to a second pane of the plurality of panes, wherein the compose interface element is configured to be selectable by a user; and in response to a user selection of the compose interface element, render a draft message composer interface to the first pane of the group-based communication interface.

Still other embodiments are directed to a computer-implemented method for managing a draft message compose interface of a group-based communication system, the computer-implemented method comprising: rendering a draft message composer interface to a group-based communication interface of the group-based communication system in response to receiving a compose draft message request comprising a user identifier, wherein the draft message composer interface comprises a destination input component; in response to detecting a non-keystroke engagement of the destination input component, determining a first destination suggestions set by querying a group-based communication suggestions repository based upon at least the user identifier; and rendering a destination suggestion interface comprising the first destination suggestions set. Other embodiments further comprise detecting a first keystroke engagement of the destination input component; determining a second destination suggestions set by querying the group-based communication suggestions repository based upon at least the user identifier and the detected first keystroke engagement; and automatically updating the destination suggestion interface to replace the first destination suggestions set with the second destination suggestions set.

In some embodiments, the group-based communication suggestions repository comprises user recipient data, group-based communication thread data, and group-based communication channel data.

In other embodiments, the first destination suggestions set comprises one or more suggested user recipients, one or more suggested group-based communication threads, one or more suggested group-based communication channels, or combinations thereof.

In some embodiments, the detected first keystroke engagement of the destination input component comprises a group-based communication channel indicator and the second destination suggestions set comprises one or more suggested group-based communication channels. In further embodiments, the group-based communication channel indicator comprises a keystroke entry of a hashtag.

In some embodiments, the computer-implemented method further comprises configuring the destination suggestion interface for user selection engagement; and generating a first destination selection indication upon user selection engagement of at least one destination suggestion item of the first destination suggestions set. In further embodiments, the computer-implemented method further comprises determining that the first destination selection indication corresponds to a group-based communication channel; and rendering a channel title tile associated with the selected group-based communication channel in the destination input component. In still further embodiments, the computer-implemented method further comprises preventing keystroke engagement of the destination input component.

In other embodiments, the channel title tile comprises a user engageable deletion element and the computer-implemented method further comprises detecting a user selection engagement of the user engageable deletion element; and stopping rendering of the channel title tile to the destination input component.

In other embodiments, the computer-implemented method further comprises configuring the destination input component to facilitate a keystroke engagement of the destination input component corresponding to one or more additional group-based communication channels; and in response to receiving one or more keystrokes corresponding to one or more additional group-based communication channels, rendering an alert message to the draft message composer interface.

In alternative embodiments, the computer-implemented method further comprises determining that the first destination selection indication corresponds to a group-based communication thread; and rendering a thread title tile associated with the selected group-based communication thread in the destination input component. In some embodiments, the computer-implemented method further comprises configuring the destination input component to prevent keystroke engagement of the destination input component. In some embodiments, the thread title tile comprises a user engageable deletion element and the computer-implemented method further comprises detecting a user selection engagement of the user engageable deletion element; and stopping rendering of the thread title tile to the destination input component.

In alternative embodiments, the computer-implemented method further comprises determining that the first destination selection indication corresponds to one or more selected user recipients; rendering a user identifier tile associated with each user recipient of the one or more selected user recipients in the destination input component; configuring the destination input component to facilitate a keystroke engagement of the destination input component corresponding to one or more additional selected user recipients; determining an additional user recipient suggestions set; and automatically updating the destination suggestion interface to replace the first destination suggestions set with the additional user recipient suggestions set.

In some embodiments, determining the additional user recipient suggestions set is based upon at least the user identifier associated with the compose draft message request and the first destination selection indication.

In some embodiments, each user identifier tile comprises a user engageable deletion element and the computer-implemented method further comprises detecting a user selection engagement of at least one of the user engageable deletion elements; and stopping rendering of at least one of the user identifier tiles to the destination input component.

In some embodiments, determining the first destination suggestions set by querying the group-based communication suggestions repository based upon at least the user identifier comprises querying the group-based communication suggestions repository for destination suggestion items; retrieving user profile data associated with the user identifier from the group-based communication suggestions repository; ranking the destination suggestion items returned by the query based on the retrieved user profile data; and determining the first destination suggestions set based on the ranking of the destination suggestion items. In further embodiments, the user profile data stored in the group-based communication suggestions repository comprises at least one of user role data, user organization data, user topic data, historical channel interaction data, historical thread interaction data, historical user interaction data, or combinations thereof.

In other embodiments, the compose draft message request further comprises a current group identifier associated with the group-based communication interface and the retrieved user profile data comprises one or more additional group identifiers associated with the user identifier. In further embodiments, the destination suggestion items returned by the query comprise one or more destination suggestion items associated with the current group identifier. In other embodiments, the destination suggestion items returned by the query comprise one or more destination suggestion items associated with the one or more additional group identifiers.

In still other embodiments, the first destination suggestions set is determined by comparing the ranking of the destination suggestion items to a predetermined threshold.

In some embodiments, determining the first destination suggestions set by querying the group-based communication suggestions repository based upon at least the user identifier comprises: querying the group-based communication suggestions repository for destination suggestion items; retrieving user profile data associated with the user identifier from the group-based communication suggestions repository; ranking destination suggestion items returned by the query based on the retrieved user profile data; and determining the first destination suggestions set based on the ranking of the destination suggestion items. In still further embodiments, determining a second destination suggestions set by querying the group-based communication suggestions repository based upon at least the user identifier and the detected first keystroke engagement comprises updating the ranking of the destination suggestion items based on the retrieved user profile data and the detected first keystroke engagement to define the second destination suggestions set.

In some embodiments, the detected first keystroke engagement of the destination input component comprises a group-based communication thread indicator and the first destination suggestions set comprises one or more suggested group-based communication threads. In alternative embodiments, the detected first keystroke engagement of the destination input component comprises an user recipient indicator and the first destination suggestions set comprises one or more suggested user recipients.

In some embodiments, the computer-implemented method further comprises receiving user entry of a first destination input in the destination input component such that one or more keystroke entries are received in the destination input component.

In another embodiment, the computer-implemented method further comprises determining that the first destination selection indication corresponds to a group-based communication channel; and in response to determining that the user profile associated with the user identifier is not a member of the selected group-based communication channel, rendering an alert message to the draft message composer interface.

In still another embodiment, the computer-implemented method further comprises determining that a user profile associated with the user identifier is a member of the selected group-based communication channel prior to rendering the channel title tile associated in the destination input component. In further embodiments, determining that a user profile associated with the user identifier is a member of the selected group-based communication channel comprises comparing the user identifier to a channel membership directory associated with the selected group-based communication channel. In still further embodiments, the computer-implemented method further comprises determining that the user profile associated with the user identifier has write access privileges to the selected group-based communication channel; and rendering a channel title tile associated with the selected group-based communication channel in the destination input component. In still further embodiments, the computer-implemented method further comprises configuring the destination input component to prevent keystroke engagement of the destination input component.

In other embodiments wherein the channel title tile comprises a user engageable deletion element, the computer-implemented method further comprises detecting a user selection engagement of at least one of the user engageable deletion elements; and stopping rendering the channel title tile to the destination input component.

In still other embodiments, the computer-implemented method further comprises determining that the user profile associated with the user identifier does not have write access privileges to the selected group-based communication channel; and rendering an error indication to the draft message composer interface.

Still other embodiments are directed to a computer-implemented method for managing a drafts view interface of a group-based communication system, the computer-implemented method comprising: in response to receiving a drafts view request comprising a user identifier, querying a group- based communication drafts repository for all draft messaging communications associated with the user identifier; and rendering all draft messaging communications returned by the query to a drafts view interface. In other embodiments, each of the draft messaging communications returned by the query comprises an author identifier matching the user identifier. In still other embodiments, each of the draft messaging communications comprises a draft message title and the computer-implemented method further comprises ordering the draft messaging communications within the drafts view interface based on the draft message titles of the draft messaging communications.

In other embodiments, each of the draft messaging communications comprises a last edit timestamp title and the computer-implemented method further comprises ordering the draft messaging communications within the drafts view interface based on the last edit timestamps of the draft messaging communications.

In some embodiments, each draft messaging communication comprises a user engageable link configured to allow access to the draft messaging communication upon user selection engagement of the user engageable link. In further embodiments, the computer-implemented method further comprises detecting user selection engagement of the user engageable link; and rendering the selected draft messaging communication in a draft message composer interface.

In other embodiments, the computer-implemented method further comprises detecting user selection engagement of the user engageable link; and rendering the selected draft messaging communication in a group-based communication channel interface.

In still other embodiments, the computer-implemented method further comprises detecting user selection engagement of the user engageable link; and rendering the selected draft messaging communication in a group-based communication thread interface.

In still alternative embodiments, the computer-implemented method further comprises detecting user selection engagement of the user engageable link; and rendering the selected draft messaging communication in a direct message interface.

Still other embodiments are directed to a computer-implemented method for managing a group-based communication interface of a group-based communication system, the computer-implemented method comprising: rendering a draft message composer interface to the group-based communication interface of the group-based communication system in response to receiving a compose draft message request comprising a user identifier, wherein the draft message composer interface is associated with a draft messaging communication; and rendering a draft message placeholder in a sidebar pane of the group-based communication interface, wherein the draft message placeholder is associated with the draft messaging communication. In further embodiments, the computer-implemented method further comprises assigning a draft message title to the draft messaging communication; and automatically updating the sidebar pane of the group-based communication interface to replace the draft message placeholder with the assigned draft message title. In still further embodiments, the draft message composer interface comprises a destination input component and a draft content input component.

In still further embodiments, assigning the draft message title to the draft messaging communication comprises detecting a keystroke engagement of the draft content input component and assigning at least a portion of the detected keystroke engagement as the draft message title of the draft messaging communication.

In alternative embodiments, assigning the draft message title to the draft messaging communication comprises detecting a keystroke engagement of the destination input component and assigning at least a portion of the detected keystroke engagement as the draft message title of the draft messaging communication.

In another embodiment, the draft message placeholder in the sidebar pane comprises a user engageable link configured to allow access to the draft messaging communication upon user selection engagement of the user engageable link. In other embodiments, the draft message title in the sidebar pane comprises a user engageable link configured to allow access to the draft messaging communication upon user selection engagement of the user engageable link.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE SEVERAL VIEWS OF THE DRAWINGS

Having thus described some embodiments in general terms, reference will now be made to the accompanying drawings, which are not necessarily drawn to scale, and wherein:

FIG. 1 illustrates a schematic view of a group-based communication system in communication with client devices and external resources according to various embodiments of the present invention;

FIG. 2 shows a schematic view of a group-based communication apparatus according to one embodiment;

FIG. 3A illustrates an example draft message composer interface configured in accordance with one embodiment;

FIG. 3B illustrates an example draft message composer interface configured in accordance with another embodiment;

FIG. 3C illustrates an example draft message composer interface configured in accordance with another embodiment;

FIG. 3D illustrates an example draft message composer interface configured in accordance with another embodiment;

FIG. 4A illustrates an example draft message composer interface and a sidebar pane comprising draft message titles configured in accordance with one embodiment;

FIG. 4B illustrates an example drafts section of a sidebar pane configured in accordance with one embodiment;

FIG. 4C illustrates an example drafts section of a sidebar pane configured in accordance with another embodiment;

FIG. 5A illustrates an example draft message composer interface and a destination suggestion interface comprising a destination suggestions set in accordance with one embodiment;

FIG. 5B illustrates an example draft message composer interface a destination suggestion interface comprising an additional user recipient suggestions set in accordance with one embodiment;

FIG. 6 illustrates an example draft message composer interface and a destination suggestion interface comprising suggested group-based communication channels in accordance with one embodiment;

FIG. 7 illustrates an example draft message composer interface and a destination suggestion interface comprising suggested user recipients in accordance with one embodiment;

FIG. 8 illustrates an example draft message composer interface and a destination suggestion interface comprising suggested destination items including most recent conversations in accordance with one embodiment;

FIG. 9 illustrates an example draft message composer interface configured in accordance with one embodiment;

FIG. 10 illustrates an example drafts view interface configured in accordance with one embodiment;

FIG. 11A is a flowchart illustrating example operations for determining and rendering a first destination suggestions set in a group-based communication system in accordance with one embodiment;

FIG. 11B illustrates an example signal diagram illustrating data flow interactions between a group-based communication apparatus, a group-based communication repository, and a client device when managing a draft message composer interface in accordance with one embodiment;

FIG. 12 is a flowchart illustrating example operations for determining whether a first destination selection indication corresponds to a group-based communication channel, group-based communication thread, or user recipient in a group-based communication system in accordance with one embodiment;

FIG. 13 is a flowchart illustrating example operations for managing a drafts view interface in a group-based communication system in accordance with one embodiment; and

FIG. 14 is a flowchart illustrating example operations for rendering draft message placeholder(s) and draft message title(s) to a sidebar pane of a group-based communication interface in a group-based communication system in accordance with one embodiment.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

### Overview

In a group-based communication system, users may communicate with one another in a myriad of ways. For example, a group-based communication system may have multiple group-based communication channels organized among a plurality of group-based communication workspaces, each group-based communication workspace dedicated to a particular group or team having a defined member list (i.e., a defined list of authenticated user accounts). In this regard, users may be a member of one or more such group-based communication workspaces or one or more such group-based communication channels and communicate with one another via the group-based communication channels, group-based communication threads within the channels, or direct messaging communications.

In certain instances, it may be desirable for users to initiate or prepare a draft messaging communication without association to a particular group-based communication channel, group-based communication thread, or user recipient. In still other instances, it may be desirable for users to initiate such a draft messaging communication in an intuitive and streamlined manner. For example, a common flow to place a user within an interface to compose a draft message to another user (i.e., a draft direct messaging communication) in current group-based communication system may require numerous steps including scrolling to a dedicated direct message section, clicking on or otherwise selecting a plus icon visual indicator (e.g., ⊕) to initiate the direct message conversation, proceed to inputting one or more user recipients, and finally clicking on or otherwise selecting “Go” to launch an interface for composing a new draft message. Such steps require the user to navigate to the intended audience (i.e., identify the user recipient(s)) before composing the content of the draft message. Such a flow is not only inefficient and complicated, but also unintuitive with respect to how a user intends to create a draft message. Indeed, regardless of whether a user is new to a group-based communication system or not, a user composing a new draft message may incur unnecessary frustration when the user encounters multiple, unintuitive interfaces or fields of entry intended for composing a draft message. This problem is only exacerbated as the number of users and channels increase for any particular group-based communication workspace or group-based communication system. Accordingly, it is desirable for the group-based communication system to support more streamlined, intuitive, and easy to use draft message composer and drafts view interfaces, as well as dedicated composition flows that are optimized for composing and accessing draft messages in such a group-based communication system.

Applicant has identified that establishing a dedicated draft message composer interface and drafts view interface is important to improving any implementation of a group-based communication system. Such dedicated interfaces, removed from the requirement to identify a user's audience before composing a draft message, reduce the complexity and time it takes to create or compose a new draft message. The less complex and more intuitive the process is to create a draft message, the more likely that users will make more productive use of the group-based communication system, which leads to more users adopting and utilizing the group-based communication system.

With the improvement in the draft message composer and drafts view interfaces, as well as dedicated composition flows, Applicant has also determined it is desirable for the group-based communication apparatus to determine and provide the user with potential destination suggestions. Such suggestions may be determined based on various factors or data such as, for example, detected engagement or input from the user or the user's prior interactions with the group-based communication system. As the user continues to interact with the group-based communication apparatus, the destination suggestions may be updated and/or revised based on the additional information. Moreover, it is desirable for the group-based communication apparatus to have workspace awareness or visibility into the group-based communication channels that exist and whether or not the user has write access privileges to such channels. In other words, in some instances, only certain members are allowed to share or post to specific group-based communication channels. Accordingly, the group-based communication apparatus, in certain embodiments, ensures that the destinations input by the user and the suggested destinations are authorized and accessible to the user.

Various embodiments of the present invention are directed to an improved group-based communication apparatus that is configured to manage a draft message composer interface of a group-based communication system. Exemplary embodiments herein enable a user to initiate or otherwise compose a new draft message in a fast and efficient manner without having to invoke conventional processes that may require a more extensive series of inputs (e.g., clicks or selections), or, in some cases, the use of numerous, more complex, and less intuitive interfaces. In one example, the group-based communication apparatus renders a draft message composer interface to a group-based communication interface of the group-based communication system in response to receiving a compose draft message request comprising a user identifier, wherein the draft message composer interface comprises a destination input component. Although identification of a user recipient, group-based communication thread, or group-based communication channel is not required by the improved group-based communication apparatus in order to create a new draft message, in certain embodiments, the group-based communication apparatus is further configured to, in response to detecting a non-keystroke engagement of the destination input component, determine a first destination suggestions set by querying a group-based communication suggestions repository based upon at least the user identifier. The group-based communication apparatus, in some embodiments, also causes rendering of a destination suggestion interface comprising the first destination suggestions set, easing the process for users to compose a draft messaging communication. In another example, the destination suggestion interface is configured for user selection engagement and a first destination selection indication is generated upon user selection engagement of one of the destination suggestion items of the first destination suggestions set. Based on a determination of whether the first destination selection indication corresponds to group-based communication channel, a group-based communication thread, or one or more user recipients, the group-based communication apparatus is further configured to facilitate or prevent keystroke engagement of the destination input component.

In another example, the group-based communication apparatus is configured to render draft message placeholders and/or assign and render draft message titles of draft messaging communications to a sidebar pane of a group-based communication interface, facilitating and simplifying access to the user's draft messaging communications for further revisions or posting. In still further examples, the group-based communication apparatus is configured to allow for access to multiple draft messaging communications, unattached to a specified group-based communication channel, group-based communication thread, or user recipient(s) in a direct message conversation.

### Definitions

Certain terms used in connection with exemplary embodiments are defined below.

As used herein, the terms “data,” “content,” “digital content,” “digital content object,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, repeaters, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, repeaters, and/or the like.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in the at least one embodiment of the present invention and may be included in more than one embodiment of the present invention (importantly, such phrases do not necessarily refer to the same embodiment).

The terms “illustrative,” “example,” “exemplary” and the like are used herein to mean “serving as an example, instance, or illustration” with no indication of quality level. Any implementation described herein as “exemplary” is not necessarily to be construed as preferred or advantageous over other implementations.

The terms “about,” “approximately,” or the like, when used with a number, may mean that specific number, or alternatively, a range in proximity to the specific number, as understood by persons of skill in the art field.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The term “set” refers to a collection of one or more items.

The term “plurality” refers to two or more items.

The term “or” is used herein in both the alternative and conjunctive sense, unless otherwise indicated.

The term “client device” refers to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like. Client devices may be associated with a user. The association may be created by the client device transmitting registration information for the user to the group-based communication server. In some instances, a client device may be temporarily associated with a user (e.g., only when a user is logged onto the group-based communication system app).

The term “user” should be understood to refer to an individual, group of individuals, business, organization, and the like. Users referred to herein are discussed largely in connection with client device enabled activity for accessing a group-based communication interface (or set of group-based communication interfaces) of a group-based communication system. Each user of the group-based communication system is associated with at least one “group identifier”.

The term “group-based” is used herein to refer to a system, channel, communication, message, or virtual environment that has security sufficient such that the system, channel, communication, message, or virtual environment is accessible only to a defined group of users (e.g., users having a common group identifier associated with their respective user profiles). The group may be defined by common access credentials such as those of an organization or commercial enterprise. Access may further be facilitated by a validated request to join or an invitation to join transmitted by one group member user to another non-member user. Group identifiers (defined below) are used to associate data, information, messages, users, group-based communication channels, etc., with specific groups of a group-based communication system as defined below.

The term “group-based communication system” refers to a communications software platform and associated hardware that is configured to support and maintain a plurality of group-based communication workspaces and all associated functionality. Group-based communication system users are organized into organization groups (e.g., employees of different companies may be separate organization groups) and each organization group interacts with the system via at least one group-based communication workspace. For example, the group-based communication system might support, among others, a plurality of workspaces associated with Slack Corporation and a plurality of workspaces associated with ACME Corporation. Example group-based communication systems comprise supporting servers and client devices, and are further configured to engage external email resources.

The terms “user profile,” “user account,” “user profile data,” and “user account details” refer to data, files, and other information of a group-based communication system that is associated with a user, including, for example, a user identifier, one or more group-based communication channel identifiers (defined below) associated with group-based communication channels that the user has been granted access to, one or more group identifiers for groups with which the user is associated, an indication as to whether the user is an owner of any group-based communication channels, an indication as to whether the user has any group-based communication channel restrictions, a plurality of messages, a plurality of emojis, a plurality of conversations, a plurality of conversation topics, an avatar, avatar rendering settings, an email address, a real name (e.g., John Doe), a username (e.g., jdoe), a password, a time zone, a status, and the like. The user account details can include a subset designation of user credentials, such as, for example, login information for the user including the user's username and password.

The term “user identifier” refers to one or more items of data by which a user, a user profile, or the user's corresponding user account may be uniquely identified within a group-based communication system. For example, a user identifier may comprise American Standard Code for Information Interchange (ASCII) text, a pointer, a memory address, or other unique identifier.

The terms “group identifier,” “workspace identifier,” and “team identifier” refer to one or more items of data by which a group-based communication workspace within a group-based communication system may be uniquely identified. For example, a group identifier may comprise ASCII text, a pointer, a memory address, and the like. Group identifiers are used to distinguish group-based communication channels, messages, files, members, etc., associated with one group-based communication workspace from another group-based communication workspace.

Group-based communication system users are organized into organization groups (e.g., employees of each company may be a separate organization group) and each organization group or sub-group may have one or more group-based communication workspaces and/or group-based communication channels to which users may be assigned or which the users may join (e.g., group-based communication channels may represent departments, geographic locations such as offices, product lines, user interests, topics, issues, and/or the like). A group identifier is used to facilitate access control for a message (e.g., access to the message, such as having the message return as part of search results in response to a search query, may be restricted to those users having the group identifier associated with their user profile). The group identifier may be used to determine context for the message (e.g., a description of the group, such as the name of the group and/or a brief description of the group, may be associated with the group identifier).

Group-based communication system users may join group-based communication channels. Some group-based communication channels may be globally accessible to those users having a particular organizational identifier associated with their user profile (i.e., users who are members of the organization). Access to some group-based communication channels may be restricted to members of specified workspaces, whereby the group-based communication channels are accessible to those users having a particular group identifier associated with their user profile. The group-based communication channel identifier may be used to facilitate access control for a message (e.g., access to the message, such as having the message return as part of search results in response to a search query, may be restricted to those users having the group-based communication channel identifier associated with their user profile, or who have the ability to join the group-based communication channel). The group-based communication channel identifier may be used to determine context for the message (e.g., a description of the group-based communication channel, such as a description of a project discussed in the group-based communication channel, may be associated with the group-based communication channel identifier).

The term “group-based communication server” refers to a software platform and associated hardware that is configured to manage access to the various group-based communication interfaces of the group-based communication system. The group-based communication server is configured to access, maintain, and support application product logic of the group-based communication system and to access one or more data repositories such as a group-based communication repository.

The term “group-based communication workspace” refers to a virtual communications environment configured to facilitate user interaction with a group-based communication system, the virtual communications environment having restricted access such that it is not generally accessible and/or searchable by other members of the group-based communication system. Each group-based communication workspace is accessible and viewable to a select group of users sharing a common group identifier. The group-based communication workspace may be associated with a plurality of group-based communication channel (e.g., a marketing channel, a sales channel, an accounting channel, etc.), which are defined herein.

The term “organization identifier” refers to one or more items of data by which an organization or users associated with an organization within a group-based communication system may be uniquely identified. For example, an organization identifier may comprise ASCII text, a pointer, a memory address, and the like. The organization identifier may be associated with a select group of users, such as a group of employees of a business, enterprise, corporation, or organization (e.g., the organization identifier associated with Slack Corp. employees would be different than the organization identifier associated with ACME Corporation. The organization identifier may be associated with a plurality of group-based communication workspaces (e.g., a marketing group, a sales group, a patent group, etc.), which are defined herein. The group-based communication workspaces and channels associated with Slack Corp.'s organization identifier would not be accessible or viewable by users associated with the ACME Corporation organization identifier).

The term “group-based communication platform” refers to a computing platform embodied for the purpose of supporting a group-based communication system, as a collection of computing services that are accessible to one or more client devices, and that are operable to provide access to a plurality of software applications related to operations of databases. In some examples, the group-based communication platform may take the form of one or more central servers disposed in communication with one or more additional servers running software applications and having access to one or more databases storing digital content items, application-related data, and/or the like.

The term “group-based communication interface” is a graphical user interface of a group-based communication system that is configured to allow users to (e.g., group members) to view and engage a group-based communication workspace. A group-based communication interface is rendered to a client device based on data and instructions provided by the group-based communication system. In some embodiments, such data and instructions are facilitated by a dedicated software application running on the client device. In other embodiments, such data and instructions are provided through a web browser running on the client device.

The terms “group-based communication application” or “group-based communication app” refer to a dedicated software program, application, platform, service, web browser, or computer-executable application software programmed or configured to run on a client device which provides the user access to the group-based communication system. Such a group-based communication application is typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

The term “group-based communication channel” refers to a virtual communications environment or feed that is configured to display messaging communications posted by channel members (e.g., validated users accessing the environment using client devices) that are viewable only to the members of the channel. The format of the group-based communication channel may appear differently to different members of the group-based communication channel; however, the content of the group-based communication channel (i.e., messaging communications) will be displayed to each member of the group-based communication channel. For instance, a common set of group-based messaging communications will be displayed to each member of the respective group-based communication channel such that the content of the group-based communication channel (i.e., messaging communications) will not vary per member of the group-based communication channel. Group-based communication channels are typically organized or arranged (e.g., alphabetically) in list form within a sidebar pane of the group-based communication interface based on the channel titles or names.

The terms “group-based communication channel identifier” or “channel identifier” refer to one or more items of data by which a group-based communication channel may be uniquely identified in a group-based communication system. For example, a group-based communication channel identifier may comprise ASCII text, a pointer, a memory address, and the like.

The terms “group-based communication message,” “messaging communication,” and “message” refer to any electronically generated digital content object provided by a user using a client device that has been sent or posted to, and is configured for display within, a group-based communication channel interface or direct message conversation feed. Message communications may include any text, image, video, audio or combination thereof provided by a user (using a client device). For instance, the user may provide a messaging communication that includes text as well as an image and a video within the messaging communication as message contents. In such a case, the text, image, and video would comprise the messaging communication, digital content object, or body content data. Each message sent or posted to a group-based communication channel or direct message conversation feed of the group-based communication system includes message metadata comprising the following: a sending user identifier, a message identifier, message contents, a timestamp that identifies the time of the message, a group identifier. Each message sent or posted to a group-based communication channel further includes a group-based communication channel identifier. Each of the foregoing identifiers may comprise ASCII text, a pointer, a memory address, and the like.

The terms “direct message” or “direct messaging communication” refers specifically to a message or collection of messaging communications between two or more users of the group-based communication system in a direct message conversation feed.

The terms “draft messaging communication” and “draft message” refer to a messaging communication or message (defined above) that has not yet been sent, posted, or otherwise transmitted to a group-based communication channel, group-based communication thread, or user recipient. Draft message communications may include any text, image, video, audio or combination thereof provided by a user (using a client device). For instance, the user may provide a draft messaging communication that includes text as well as an image and a video within the draft messaging communication as draft message contents. In such a case, the text, image, and video would comprise the draft messaging communication, digital content object, or draft body content data. Each draft message of the group-based communication system includes “draft message metadata.” In some embodiments, draft message metadata comprises one or more of the following: a user identifier, an author identifier, a group identifier, draft message contents or draft body content data, and a last edit timestamp. In some embodiments, draft message metadata further comprises a channel identifier if it is associated with a group-based communication channel. In alternative embodiments, a draft message is not associated with a group-based communication channel In still other embodiments, draft message metadata further comprises a thread identifier associated with a thread. In still further embodiments, the draft message metadata comprises a thread timestamp value associated with a thread parent message if the draft message is associated with a thread. Each of the foregoing identifiers may comprise ASCII text, a pointer, a memory address, and the like.

Draft messaging communications may be “attached”/“active” or “unattached”/“inactive” depending on how the draft messaging communication originates. For instance, an “attached draft messaging communication” or “active draft messaging communication” originates from within the group-based communication channel, group-based communication thread, or direct message conversation of the group-based communication interface such that the draft messaging communication is “active” or “attached” to the group-based communication channel, group-based communication thread, or direct message conversation. In some embodiments, the group-based communication system is configured to allow one “attached” or “active” draft messaging communication per group-based communication channel, group-based communication thread, or direct message conversation. An “unattached draft messaging communication” or “inactive draft messaging communication” originates from a standalone draft messaging composer, such as a draft message composer interface, such that it is not “active” or “attached” to a group-based communication channel, group-based communication thread, or direct message conversation. In some embodiments, regardless of whether an “unattached draft messaging communication” or “inactive draft messaging communication” comprises destination input, such as a user recipient, group-based communication thread, or group-based communication channel, the “unattached draft messaging communication” or “inactive draft messaging communication” is configured to remain “unattached” or “inactive” unless and until it is posted as a messaging communication to a group-based communication channel or group-based communication thread or otherwise transmitted to one or more user recipients via a direct message conversation. In some embodiments, the group-based communication system is configured to allow for a plurality of “unattached” or “inactive” draft messaging communications.

The term “group-based communication thread” or “thread” is a collection of message communications displayed in a subsidiary feed arising from or otherwise associated with a selected group-based messaging communication displayed in a selected group-based communication channel. A group-based communication thread may include one or more “threaded messages” or “thread communication messages” that are linked together in the subsidiary feed, wherein each is associated with the selected group-based messaging communication or “parent message”.

The term “last edit timestamp” refers to a digital representation of network time associated with the saving of a draft messaging communication, thus, indicative of when an edit to or the creation of a draft messaging communication last occurred.

The term “group-based communication object” refers to electronic data objects or digital content objects specifically executable and/or otherwise accessible via the group-based communication system and/or at least one external resource. Group-based communication objects may be received at the group-based communication system by receiving those group-based communication objects conveyed to (pushed to) the group-based communication system, or the group-based communication system may retrieve (pull to) various group-based communication objects stored within accessible storage areas of one or more client devices, external resources, and/or the like. The group-based communication objects include body content data and metadata. The body content data of the group-based communication objects may be interpreted by the group-based communication apparatus to display or otherwise convey human-readable representations of information and/or computer-executable content that causes a particular client device to operate in a particular way. Specifics of certain group-based communication objects examples are discussed herein, however, it should be understood that in certain embodiments, group-based communication objects may be embodied as messaging communications, draft messaging communications, emails, events, audio files, video files, document files, spreadsheet files, presentation files, tasks, and/or the like; as well as any contextual data corresponding therewith. Group-based communication objects may thus be non-personal (alternatively referred to as public) as they are exchanged between a plurality of users or otherwise made available to a plurality of users. Alternatively, group-based communication objects may be personal in nature (e.g., as defined by a portion of metadata associated with the group-based communication object), such that access to the content of the group-based communication object is limited to a single user (or a limited number of defined users). For example, group-based communication objects personal to a single user may encompass tasks or task lists defined personally by and for a particular user. Access to personal group-based communication objects may be limited to access requests associated with defined user identifiers. In certain embodiments, personal group-based communication objects may be represented as encrypted data when indexed in database storage areas and/or when included within work graph data structures including personal and non-personal group-based communication objects.

A “sending user identifier” is associated with a collection of messages that are sent by a particular user (e.g., sent by a client device associated with the particular user, client identifier, user identifier, or user profile). These messages may be analyzed or parsed to determine context regarding the user (e.g., the user's expertise or interest in a topic may be determined based on the frequency of mention of the topic or key words associated with the topic within such messages). A sending user identifier may comprise ASCII text, a pointer, a memory address, and the like.

An “author identifier” is associated with a collection of draft messaging communications that are authored by a particular user (e.g., created by a client device associated with the particular user, user identifier, or user profile). An author identifier may comprise ASCII text, a pointer, a memory address, and the like.

Access to a group-based communication channel may be subject to various levels of permissions and/or privileges. For instance, read access privileges may be permitted for all members of a specified group in a specific group-based communication channel, however, only certain members may be granted “write access privileges” such that they may post messages to the specific group-based communication channel. For example, a group-based communication channel dedicated to announcements for a specific group may validate all users of a group identifier to read messages in the announcements channels, but only those users or administrators who have been granted write access privileges may be able to post messages to the announcements channel.

The term “private group-based communication channel” refers to a group-based communication channel with restricted access settings such that it is not generally accessible and/or searchable by other members of the group-based communication system (i.e., members associated with other group-based communication workspaces). For example, only those users or administrators who have knowledge of and permission to access (e.g., a group-based communication channel identifier for the private group-based communication channel is associated with their user profile after the user has been validated/authenticated) the private group-based communication channel may view content of the private group-based communication channel.

The term “permitted group-based communication channel(s)” refers to one or more group-based communication channels or private group-based communication channels that have been approved or authenticated for access by a user (e.g., a user profile) associated with a selected user identifier.

The term “compose draft message request” refers to an electrically generated digital object that indicates that a user has provided an input comprising a request to compose a draft messaging communication. A compose draft message request may be represented via a temporary code that notifies a recipient that a user has made the request. To provide further context, a compose draft message request is generated in response to a user interaction with a group-based communication interface presented on a display screen of a client device. A user can initiate a compose draft message request, for example, by interacting with a specific compose draft message actuator button that forms part of the group-based communication interface.

The term “drafts view request” refers to an electrically generated digital object that indicates that a user has provided an input comprising a request to view all draft messaging communications. To provide further context, a drafts view request is generated in response to a user interaction with a group-based communication interface presented on a display screen of a client device. A user initiate a drafts view request, for example, by interacting with a specific drafts view actuator button that forms part of the group-based communication interface. In some embodiments, the user may interact with a user engageable link in a sidebar pane of the group-based communication interface which is configured to launch the drafts view request.

The term “user input” refers to user interaction, via a graphical user interface, with the group-based communication interface or components thereof. Such user input with the draft message composer interface or components thereof may be via a multitude of interactions, such as, but not limited to, “non-keystroke engagement” or “keystroke engagement.” Non-keystroke engagement refers to user interaction in which such user interaction is free from (i.e., excludes) the entering of one or more (e.g., keystroke) characters into a group-based communication interface. For example, touch-screen or mouse click engagement with a destination input component is one example of non-keystroke engagement. The term “keystroke engagement” refers to entering of one or more keystrokes into, for example, a destination input component of the draft message composer interface of the group-based communication interface. For example, input of one or more characters (e.g., alphanumeric characters or emojis) into a destination input component or a draft content input component is one example of keystroke engagement. In some embodiments, once detected, the user input (i.e., the detected keystroke engagement) forms the draft message contents or draft body content data of a draft messaging communication. In still further embodiments, at least a portion of the user input (i.e., the detected keystroke engagement) entered in a draft content input component or a destination input component forms the draft message title of a draft messaging communication.

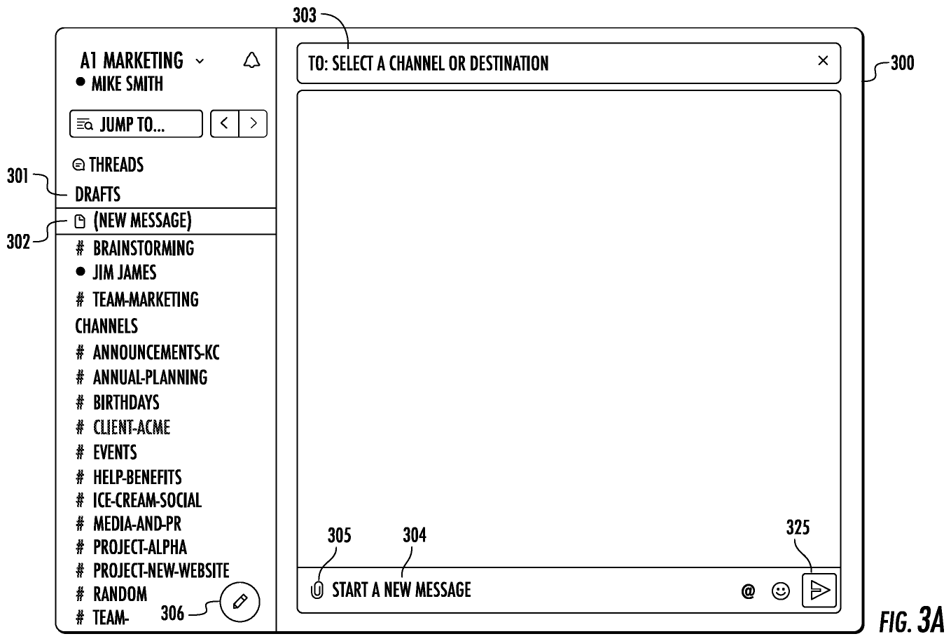

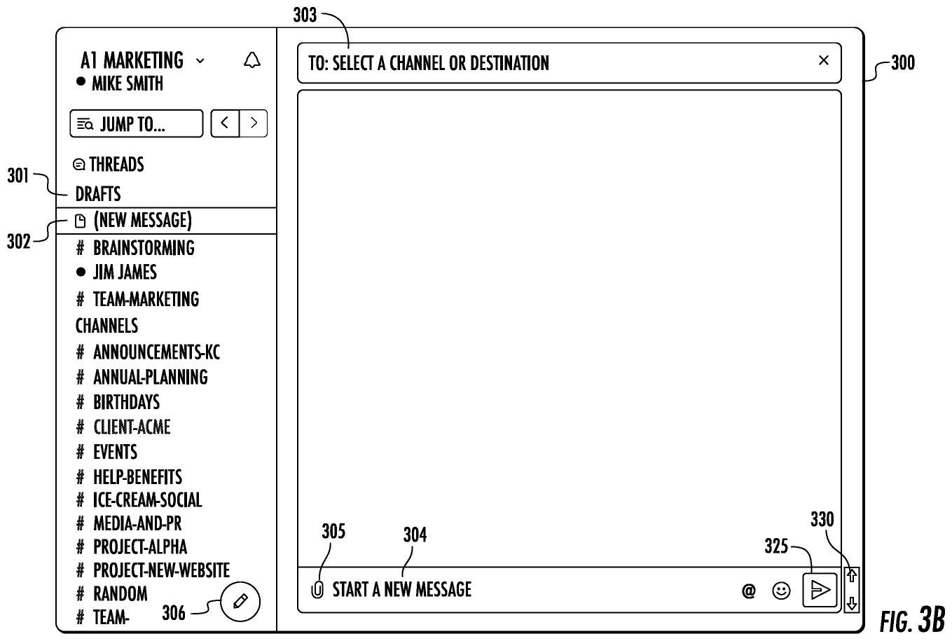

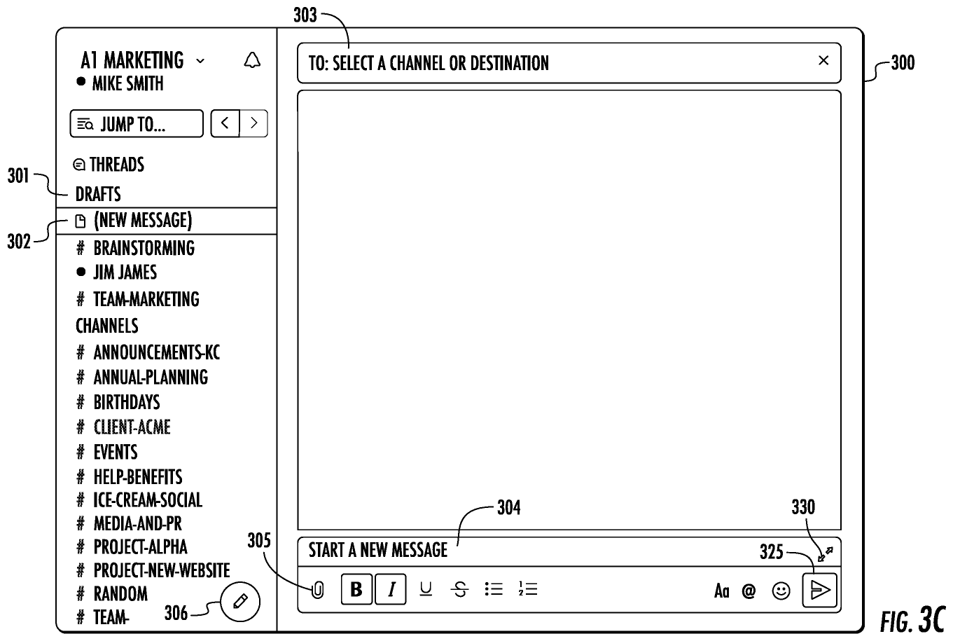

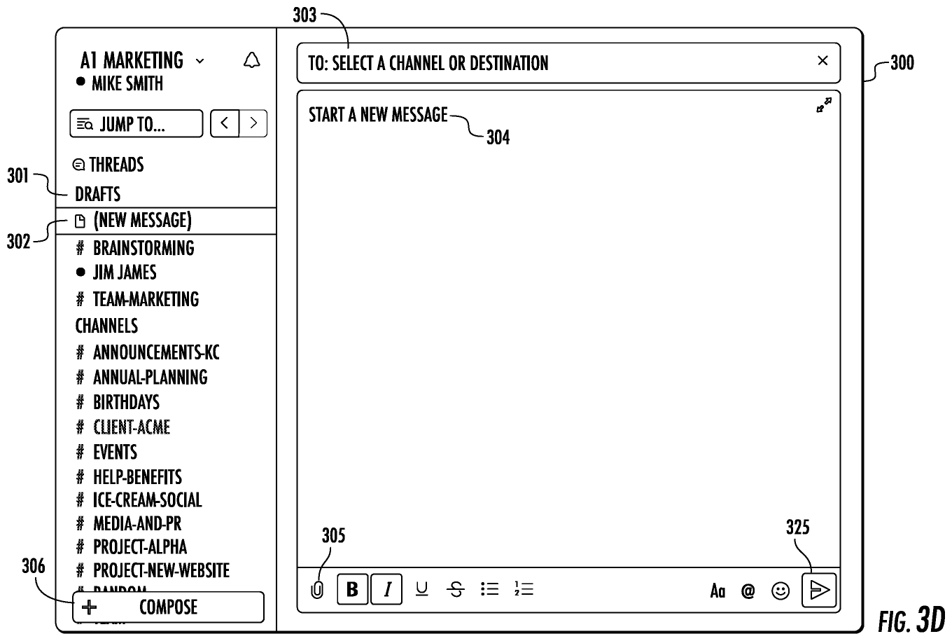

The term “draft message composer interface” refers to a user interface element that is rendered to a group-based communication interface and is configured to enable a user to generate, compose, view, input, edit and/or modify draft messaging communications. In some embodiments, the draft message composer interface is a standalone, individual component of a group-based communication interface (a single pane or component being visible within a particular display window). The draft message composer interface 300 of FIGS. 3A-3D are examples of draft message composer interfaces.

The term “destination input component” refers to a user interface element that is rendered as a portion of a draft message composer interface and is configured to enable a user to designate a destination to which the draft messaging communication is directed. In particular embodiments, the user entry (e.g., non-keystroke or keystroke engagement) in the destination input component is not required as part of composing a draft messaging communication. In such instances, the destination input component may be left blank. In some embodiments, the destination input entered by the user (e.g., a first destination selection indication is generated upon user selection engagement of a destination suggestion item or the system detects keystroke engagement corresponding to a destination input) is one or more user recipients in relation to a draft messaging communication. In such instances where it is determined that the destination input is or corresponds to one or more user recipients, the destination input component is configured to facilitate keystroke engagement (e.g., a second keystroke engagement) of the destination input component corresponding to one or more additional selected user recipients. In such embodiments, a maximum number of user recipients may be established. For example, the maximum number of user recipients to be selected in the destination input component may be set to nine (9) user recipients. In still further embodiments, first destination selection indication or the keystroke engagement is determined to correspond to a group-based communication channel or a group-based communication thread in relation to a draft messaging communication. In some embodiments, the destination input component is configured to prevent keystroke engagement of the destination input component. Thus, the user is unable to provide additional destination input(s). In other embodiments, the group-based communication apparatus is configured to allow entry of additional destinations, but provides an alert message, warning, or indication to the group-based communication interface in the event a maximum number of destinations or types of destinations is inputted in the destination input component. For example, the maximum number of group-based communication channels to be identified in the destination input component may be set to one (1) group-based communication channel. In some embodiments, the destination input component is configured to prevent user entry of destination inputs of more than one type. For example, once a user enters a user recipient, the destination input component is configured to prevent user entry of a group-based communication channel. In other examples, once a user enters a group-based communication channel, the destination input component is configured to prevent user entry of a user recipient. In still further embodiments, the destination input component is configured to receive user entry of destination inputs of more than one type.

In still further embodiments, the group-based communication apparatus is configured to respond to the ability of the user to send or post messages to a selected destination in the destination input component. For example, if a user does not have access privileges to a selected destination, the group-based communication apparatus is configured to render an alert message, warning, or indication to the group-based communication interface. In such instances, the draft content input component (described below) is configured to disable the Send button, such that the user is prevented from sending or posting a message to the selected destination.

The term “destination suggestion interface” refers to a user interface element that is rendered as a portion of a draft message composer interface and is configured to display destination suggestions set and destination suggestion items to a user.

The term “draft content input component” refers to a user interface element that is rendered as a portion of a draft message composer interface and is configured to enable a user to enter user input (i.e., keystroke engagement, attachments, etc.) which forms the draft message contents or draft body content data of a draft messaging communication. In some embodiments, the features associated with and the capabilities of the draft content input component differ from channel to channel or destination to destination. For example, in some embodiments, the group-based communication apparatus is configured to query the group-based communication suggestions repository for user preferences associated with a selected destination. That is, in some embodiments, the user has specific user preferences and/or capabilities associated with certain group-based communication channels. For example, although a user is associated with multiple channels, the user has certain additional emojis, templates, etc. associated with a selected group-based communication channel that are not available to all group-based communication channels. Such user preferences may be associated with the group identifier in some embodiments and/or the user identifier in some embodiments, and/or the channel identifier in some embodiments. In some embodiments, once a user inputs a destination in the destination input component, the group-based communication apparatus is configured to facilitate access to the user preferences in the draft content input component.

The term “attach object component” refers to a user interface element that is rendered as a portion of a draft message composer interface and is configured to enable a user to attach an object (i.e., other messaging communications, other draft messaging communications, emails, events, audio files, video files, document files, spreadsheet files, presentation files, tasks, and/or the like). In some embodiments, the attach object component may be a specific attach object actuator button that forms part of the draft message composer interface and with which the user can interact. In still further embodiments, the attach object component is configured to allow for “drag and drop” of objects to be attached inline or appended to the draft messaging communication.

The term “indicator” refers to a keystroke entry of one or more characters (e.g., alphanumeric characters or emojis) from which the group-based communication apparatus is able to determine the “type” of destination suggestion items to query and/or include in a destination suggestions set. Indicators include, but are not limited to, group-based communication channel indicators, group-based communication thread indicators, and user recipient indicators. An example of a group-based communication channel indicator is a keystroke entry of a hashtag.

The term “historical channel interaction data” refers to data generated based on user interaction with one or more group-based communication channels with which a user is associated. Such historical channel interaction data is associated with each user profile or user identifier and is stored in a group-based communication suggestions repository. Such data may be used by the group-based communication apparatus to rank items, such as destination suggestion items to be rendered to a user.

The term “historical thread interaction data” refers to data generated based on user interaction with one or more group-based communication threads with which a user is associated. Such historical thread interaction data is associated with each user profile or user identifier and is stored in a group-based communication suggestions repository. Such data may be used by the group-based communication apparatus to rank items, such as destination suggestion items to be rendered to a user.

The term “historical user interaction data” refers to data generated based on user interaction with the group-based communication system. For example, historical user interaction data may be generated based on a user's group-based communication messages, the group-based communication channels with which a user interacts or is associated, or other user accounts with which a user interacts. Such historical user interaction data is associated with each user profile or user identifier and is stored in a group-based communication suggestions repository. Such data may be used by the group-based communication apparatus to rank items, such as destination suggestion items to be rendered to a user.

The term “user organization data” refers to an organization or commercial enterprise to which the user is related or employed by (e.g., employees of different companies may be separate organization groups). User organization data may be associated with an organization identifier. Such user organization data is associated with each user profile or user identifier and is stored in a group-based communication suggestions repository. Such data may be used by the group-based communication apparatus to rank items, such as destination suggestion items to be rendered to a user.

The term “user topic data” refers to conversation topics with which the user is associated. For example, a particular user's messages may be analyzed or parsed to determine a topical context regarding the user (e.g., the user's expertise or interest in a topic may be determined based on the frequency of mention of the topic or key words associated with the topic within such messages). Such user topic data is associated with each user profile or user identifier and is stored in a group-based communication suggestions repository. Such data may be used by the group-based communication apparatus to rank items, such as destination suggestion items to be rendered to a user.

The term “user role data” refers to one or more role(s) with which the user is associated. For example, a particular user's role, such as head of HR, is associated with that particular user's profile or user identifier and is stored in a group-based communication suggestions repository. Such data may be used by the group-based communication apparatus to rank items, such as destination suggestion items to be rendered to that particular user.

The term “draft message placeholder” refers to an object configured to be rendered to the group-based communication interface in place of one or more draft message titles when the one or more draft message titles are not yet assigned to a draft messaging communication. In some embodiments, one or more draft message placeholders may be rendered in a sidebar pane where a list of draft messaging communications is rendered. The draft message placeholder is rendered unless and until the one or more “draft message titles” is assigned or otherwise becomes available with respect to a draft messaging communication. In some embodiments, at least a portion of detected user input (i.e., keystroke engagement) entered in the draft content input component of a draft message composer interface is assigned as the draft message title. In other embodiments, at least a portion of detected user input (i.e., keystroke engagement) entered in the destination input component of a draft message composer interface is assigned as the draft message title. In still further embodiments, the sidebar pane of the group-based communication interface is automatically updated to replace a draft message placeholder with the draft message title of a draft messaging communication once the draft message title is assigned. In still further embodiments, when rendered in the sidebar pane, the draft message placeholder comprises a user engageable link configured to allow access to the draft messaging communication upon user selection engagement of the user engageable link. The length of the displayed draft message title and/or draft message placeholder is limited by the width of the sidebar pane in some embodiments. For example, in some embodiments, a draft message title may be limited to 24 letters and the remainder is truncated to facilitate the space provided in the sidebar pane to the which the draft message title is rendered.

The term “external resource” refers to a software program, application, platform, or service that is configured to communicate with the group-based communication system for providing an external service (i.e., not native to the group-based communication system) to a client device via a group-based communication interface and/or via a group-based communication workspaces.

The term “external resource user identifier” refers to one or more items of data by which a user (or user profile) of an external resource may be uniquely identified by a group-based communication system. For example, an external resource user identifier may comprise ASCII text, a pointer, a memory address, and the like. One or more external resource user identifiers may be stored to a user profile of a group-based communication system along with other identifiers (e.g., user identifier, group identifiers, group-based communication channel identifiers, etc.). The external resource user identifier may be embodied in a format native to the external resource or may be structured in a format designated by the group-based communication system. Correlating one or more external resource user identifiers to a user account or user identifier of the group-based communication system allows the group-based communication system to link accounts from disparate external resources with a selected group-based communication system user account. The external resource user identifier may include an integer identifier, a universally unique identifier, an email address, a random string, and/or the like. In such a case, the group-based communication server may receive the external resource user identifier during the open authorization (OAuth) process.

The term “group-based communication repository” refers to the location, such as a memory device, where one or more user activity data logs or other group-based communication data are stored. The group-based communication repository may be a dedicated device and/or a part of a larger repository. The group-based communication repository may be dynamically updated or be static. For example, the user activity data logs may be uploaded to the group-based communication repository simultaneously with the creation of the user activity data logs. Alternatively, the user activity data logs may not be uploaded simultaneously with their creation and instead may be batch uploaded based on other factors, such as based on time intervals (e.g., uploads occur every 15 minutes), user initiation (e.g., user may press a button to initiate the upload), or the like. The group-based communication repository may be encrypted in order to limit unauthorized access of user activity data logs and associated engagement data. Examples of a group-based communication repository include the group-based communication suggestions repository and the group-based communication drafts repository. In some embodiments, the group-based communication suggestions repository stores data associated with user identifiers, i.e. user profile data, including user role data, user organization data, user topic data, historical channel interaction data, historical thread interaction data, historical user interaction data, or combinations thereof. In still further embodiments, the group-based communication suggestions repository comprises user recipient data, group-based communication thread data, and group-based communication channel data. Such data can be queried by the group-based communication apparatus.

### Example System Architecture

Methods, apparatuses, and computer program products of the present disclosure may be embodied by any of a variety of devices. For example, the method, apparatus, and computer program product of an example embodiment may be embodied by a networked device (e.g., an enterprise platform), such as a server or other network entity, configured to communicate with one or more devices, such as one or more client devices. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, or any combination of the aforementioned devices.

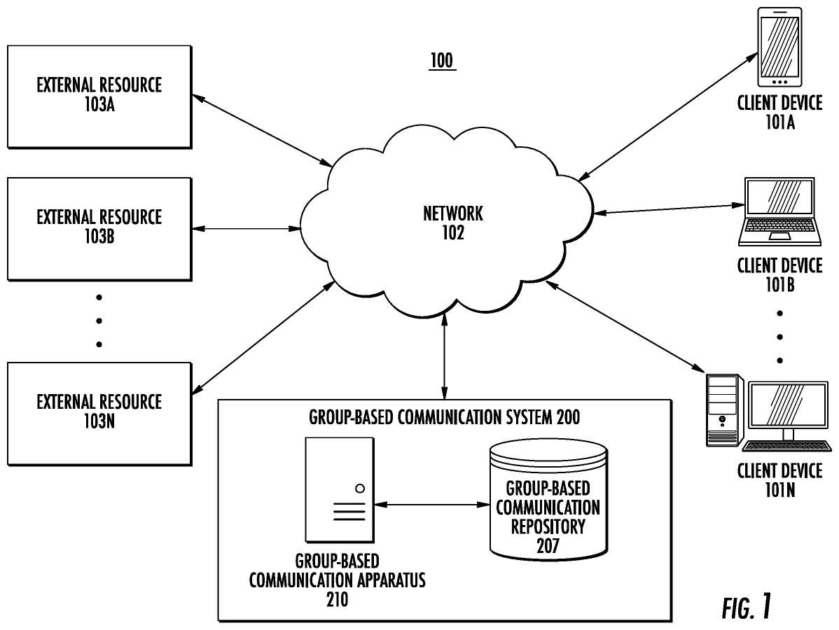

FIG. 1 illustrates an example computing system 100 within which embodiments of the present disclosure may operate. Users may access a group-based communication system 200 via a communications network 102 using client devices 101A-101N. The group-based communication system 200 may comprise a group-based communication apparatus 210 in communication with at least one group-based communication repository 207, such as the group-based communication suggestions repository. Users may further access features or services of one or more external resources 103A-103N through the group-based communication system 200.

Communications network 102 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, communications network 102 may include a cellular telephone, an 802.11, 802.16, 802.20, and/or WiMax network. Further, the communications network 102 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the group-based communication system. In some embodiments, the protocol is a custom protocol of JSON (JavaScript Object Notation) objects sent via a Websocket channel. In some embodiments, the protocol is JSON over RPC (“remote procedural call”), JSON over REST(“Representational State Transfer”)/HTTP (“HyperText Transfer Protocol”), and the like.

The group-based communication apparatus 210 may be embodied as a computer or computers. The group-based communication apparatus 210 may provide for receiving of electronic data from various sources, including but not necessarily limited to the client devices 101A-101N. For example, the group-based communication apparatus 210 may be operable to receive and post or transmit group-based messaging communications provided by the client devices 101A-101N.

The group-based communication repository 207 may be embodied as a data storage device(s) such as a Network Attached Storage (NAS) device or devices, or as a separate database server or servers. The group-based communication repository 207 includes information accessed and stored by the group-based communication apparatus 210 to facilitate the operations of the group-based communication system 200. For example, the group-based communication repository 207 may include, without limitation, a plurality of messaging communications organized among a plurality of group-based communication channels, a plurality of draft messaging communications, and/or the like. A specific example of a group-based communication repository 207 includes the group-based communication suggestions repository as described herein. Such group-based communication suggestions repository may include, without limitation, user profile data, user role data, user organization data, user topic data, historical channel interaction data, historical thread interaction data, historical user interaction data, user recipient data, group-based communication thread data, and group-based communication channel data.

The client devices 101A-101N may be any computing device as defined above. Electronic data received by the group-based communication apparatus 210 from the client devices 101A-101N may be provided in various forms and via various methods. For example, the client devices 101A-101N may include desktop computers, laptop computers, smartphones, netbooks, tablet computers, wearables, and the like.

In embodiments where a client device 101A-101N is a mobile device, such as a smartphone or tablet, the client device 101A-101N may execute an “app” to interact with the group-based communication system 200. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

Additionally, or alternatively, the client device 101A-101N may interact with the group-based communication system 200 via a web browser. As yet another example, the client devices 101A-101N may include various hardware or firmware designed to interface with the group-based communication system 200.

Each of external resources 103A-103N represents an external system, resource, service, software application, computer, or the like, that a user of a client device associated with a corresponding group-based communication system user account may access via the group-based communication system 200. For example, the group-based communication system 200 may access an external resource via one or more application programming interfaces (APIs). An external resource may provide a specific service via a group-based communication interface of the group-based communication system 200. In one example, an external resource 103A may be a validated software source code repository, or the like, which members of a group-based communication workspace may collectively access as they collaborate to develop a new software application.

An external resource 103A-103N may be embodied in a variety of ways utilizing a variety of computing devices. For example, an external resource 103A-103N may be a computer or server remote from the group-based communication system 200 and accessible over the communication network 102 (e.g., over the Internet for example).

In some embodiments, the group-based communication system 200 is configured to access an external resource utilizing an external resource user identifier stored by the group-based communication system 200, such as in group-based communication repository 207. The external resource user identifier may include, or otherwise be associated with and retrievable together with, an external resource access token associated with the external resource and/or group-based communication system user account. A group-based communication system 200 may store one or more external resource user identifiers including or associated with an external resource access token(s) to enable API requests to the external resource.

In some embodiments of an exemplary group-based communication system 200, a message or messaging communication may be sent from a client device 101A-101N to a group-based communication system 200. In various implementations, the message may be sent to the group-based communication system 200 over communications network 102 directly by a client device 101A-101N, the message may be sent to the group-based communication system 200 via an intermediary such as a message server, and/or the like. For example, the client device 101A-101N may be a desktop, a laptop, a tablet, a smartphone, and/or the like that is executing a client application (e.g., a group-based communication app). In one implementation, the message may include data such as a message identifier, sending user identifier, a group identifier, a group-based communication channel identifier, message contents (e.g., text, emojis, images, links), attachments (e.g., files), message hierarchy data (e.g., the message may be a reply to another message), third party metadata, and/or the like.

In one embodiment, the client device 101A-101N may provide the following example message, substantially in the form of a (Secure) Hypertext Transfer Protocol (“HTTP(S)”) POST message including eXtensible Markup Language (“XML”) formatted data, as provided below:

POST /authrequest.php HTTP/1.1
Host: www.server.com
Content-Type: Application/XML
Content-Length: 667
<?XML version = “1.0” encoding = “UTF-8”?>
<auth_request>

<timestamp>2020-12-31 23:59:59</timestamp>
<user_accounts_details>

<user_account_credentials>

<user_name>ID_user_1</user_name>
<password>abc123</password>
//OPTIONAL <cookie>cookieID</cookie>
//OPTIONAL <digital_cert_link>www.mydigitalcertificate.com/

JohnDoeDaDoeDoe@gmail.com/mycertifcate.dc</digital_cert_link>

//OPTIONAL <digital_certificate>_DATA_</digital_certificate>

</user_account_credentials>

</user_accounts_details>
<client_details> //iOS Client with App and Webkit

//it should be noted that although several client details
//sections are provided to show example variants of client
//sources, further messages will include only on to save
//space

<client_IP>10.0.0.123</client_IP>
<user_agent_string>Mozilla/5.0 (iPhone; CPU iPhone OS 7_1_1 like Mac OS X)

AppleWebKit/537.51.2 (KHTML, like Gecko) Version/7.0 Mobile/11D201 Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>app with webkit</client_app_type>
<app_installed_flag>true</app_installed_flag>
<app_name>nickname.app</app_name>
<app_version>1.0 </app_version>
<app_webkit_name>Mobile Safari</client_webkit_name>
<client_version>537.51.2</client_version>

</client_details>
<client_details> //iOS Client with Webbrowser

<client_IP>10.0.0.123</client_IP>
<user_agent_string>Mozilla/5.0 (iPhone; CPU iPhone OS 7_1_1 like Mac OS X)

AppleWebKit/537.51.2 (KHTML, like Gecko) Version/7.0 Mobile/11D201 Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>web browser</client_app_type>
<client_name>Mobile Safari</client_name>
<client_version>9537.53</client_version>

</client_details>
<client_details> //Android Client with Webbrowser

<client_IP>10.0.0.123</client_IP>
<user_agent_string>Mozilla/5.0 (Linux; U; Android 4.0.4; en-us; Nexus S

Build/IMM76D) AppleWebKit/534.30 (KHTML, like Gecko) Version/4.0 Mobile
Safari/534.30</user_agent_string>

<client_product_type>Nexus S</client_product_type>
<client_serial_number>YXXXXXXXXZ</client_serial_number>
<client_UDID>FXXXXXXXXX-XXXX-XXXX-XXXX-

XXXXXXXXXXXXX</client_UDID>

<client_OS>Android</client_OS>
<client_OS_version>4.0.4</client_OS_version>
<client_app_type>web browser</client_app_type>
<client_name>Mobile Safari</client_name>
<client_version>534.30</client_version>

</client_details>
<client_details> //Mac Desktop with Webbrowser

<client_IP>10.0.0.123</client_IP>
<user_agent_string>Mozilla/5.0 (Macintosh; Intel Mac OS X 10_9_3)

AppleWebKit/537.75.14 (KHTML, like Gecko) Version/7.0.3 Safari/537.75.14</user_agent_string>

<client_product_type>MacPro5,1</client_product_type>
<client_serial_number>YXXXXXXXXZ</client_serial_number>
<client_UDID>FXXXXXXXXX-XXXX-XXXX-XXXX-

XXXXXXXXXXXXX</client_UDID>

<client_OS>Mac OS X</client_OS>
<client_OS_version>10.9.3</client_OS_version>
<client_app_type>web browser</client_app_type>
<client_name>Mobile Safari</client_name>
<client_version>537.75.14</client_version>

</client_details>
<message>

<message_identifier>ID_message_10</message_identifier>
<team_identifier>ID_team_1</team_identifier>
<channel_identifier>ID_channel_ 1</channel_identifier>
<body contents>That is an interesting invention. I have attached a copy our patent

policy.</body contents>

<attachments>patent_policy.pdf</attachments>

</message>

</auth_request>

The group-based communication system 200 comprises at least one group-based communication apparatus 210 that may create a storage message based upon the received message to facilitate message indexing and storage in a group-based communication repository 207. In one implementation, the storage message may include data such as a message identifier, a group identifier, a group-based communication channel identifier, a sending user identifier, topics, responses, message contents (i.e., body contents), attachments, message hierarchy data, third party metadata, conversation primitive data, and/or the like. For example, the group-based communication apparatus 210 may provide the following example storage message, substantially in the form of a HTTP(S) POST message including XML-formatted data, as provided below:

POST /storage_message.php HTTP/1.1
Host: www.server.com
Content-Type: Application/XML
Content-Length: 667
<?XML version = “1.0” encoding = “UTF-8”?>
<storage_message>

<message_identifier>ID_message_10</message_identifier>
<team_identifier>ID_team_1</team_identifier>
<channel_identifier>ID_channel_1</channel_identifier>
<sending_user_identifier>ID_user_1</sending_user_identifier>
<topics>

<topic>disclosures</topic>
<topic>patents</topic>
<topic>policies</topic>

</topics>
<responses>

<response>liked by ID_user_2</response>
<response>starred by ID_user_3</response>

</responses>
<body contents>That is an interesting disclosure. I have attached a copy our patent policy.</body

contents>

<attachments>patent_policy.pdf</attachments>
<conversation_primitive>

conversation includes messages: ID_message_8, ID_message_9, ID_message_10,

ID_message_11, ID_message_12
</conversation_primitive>

</storage_message>

In embodiments, a sending user identifier may be associated with the message communication. In one implementation, the message may be parsed (e.g., using PHP—i.e., the script language derived from Personal Home Page Tools—commands) to determine a sending user identifier of the user who sent the message.

In some embodiments, topics may be associated with the message. In one implementation, the message contents may be parsed (e.g., using PHP commands) to determine topics discussed in the message. For example, hashtags in the message may indicate topics associated with the message. In another example, the message may be analyzed (e.g., by itself, with other messages in a conversation primitive) or parsed using a machine learning technique, such as topic modeling, to determine topics associated with the message.

In embodiments, data indicating responses may be associated with the message. For example, responses to the message by other users may include reactions (e.g., selection of an emoji associated with the message, selection of a “like” button associated with the message), clicking on a hyperlink embedded in the message, replying to the message (e.g., posting a message to the group-based communication channel in response to the message), downloading a file associated with the message, sharing the message from one group-based communication channel to another group-based communication channel, pinning the message, starring the message, and/or the like. In one implementation, data regarding responses to the message by other users may be included with the message, and the message may be parsed (e.g., using PHP commands) to determine the responses. In another implementation, data regarding responses to the message may be retrieved from a database. For example, data regarding responses to the message may be retrieved via a MySQL database command similar to the following:

SELECT messageResponses
FROM MSM_Message
WHERE messageID = ID_message_10.

For example, data regarding responses to the message may be used to determine context for the message (e.g., a social score for the message from the perspective of some user). In another example, data regarding responses to the message may be analyzed to determine context regarding the user (e.g., the user's expertise in a topic may be determined based on the responses to the user's message regarding the topic).

In some embodiments, attachments may be included with the message. If there are attachments, files may be associated with the message. In one implementation, the message may be parsed (e.g., using PHP commands) to determine file names of the attachments. For example, file contents may be analyzed to determine context for the message (e.g., a patent policy document may indicate that the message is associated with the topic “patents”).

In embodiments, third party metadata may be associated with the message. For example, third party metadata may provide additional context regarding the message or the user that is specific to a company, group, a group-based communication workspace, a group-based communication channel, and/or the like. In one implementation, the message may be parsed (e.g., using PHP commands) to determine third party metadata. For example, third party metadata may indicate whether the user who sent the message is an authorized representative of the group-based communication channel (e.g., an authorized representative may be authorized by the company to respond to questions in the group-based communication channel).

In embodiments, a conversation primitive may be associated with the message. In one implementation, a conversation primitive is an element used to analyze, index, store, and/or the like, messages. For example, the message may be analyzed by itself, and may form its own conversation primitive. In another example, the message may be analyzed along with other messages that make up a conversation, and the messages that make up the conversation may form a conversation primitive. In one implementation, the conversation primitive may be determined as the message, a specified number (e.g., two) of preceding messages and a specified number (e.g., two) of following messages. In another implementation, the conversation primitive may be determined based on analysis of topics discussed in the message and other messages (e.g., in the group-based communication channel) and/or proximity (e.g., message send order proximity, message send time proximity) of these messages.

In embodiments, various metadata, determined as described above, and/or the contents of the message may be used to index the message (e.g., using the conversation primitive) to facilitate various facets of searching (i.e., search queries that return results from group-based communication repository 207). In one implementation, a storage message may be sent from group-based communication apparatus 210 to facilitate indexing in group-based communication repository 207. In another implementation, metadata associated with the message may be determined and the message may be indexed in group-based communication repository 207. In one embodiment, the message may be indexed such that a company's or a group's messages are indexed separately (e.g., in a separate index associated with the group and/or company that is not shared with other groups and/or companies). In one implementation, messages may be indexed at a separate distributed repository (e.g., to facilitate data isolation for security purposes).

If there are attachments associated with the message, file contents of the associated files may be used to index such files in group-based communication repository 207 to facilitate searching. In one embodiment, the files may be indexed such that a company's or a group's files are indexed at a separate distributed repository.

### Example Apparatus for Implementing Embodiments of the Present Disclosure

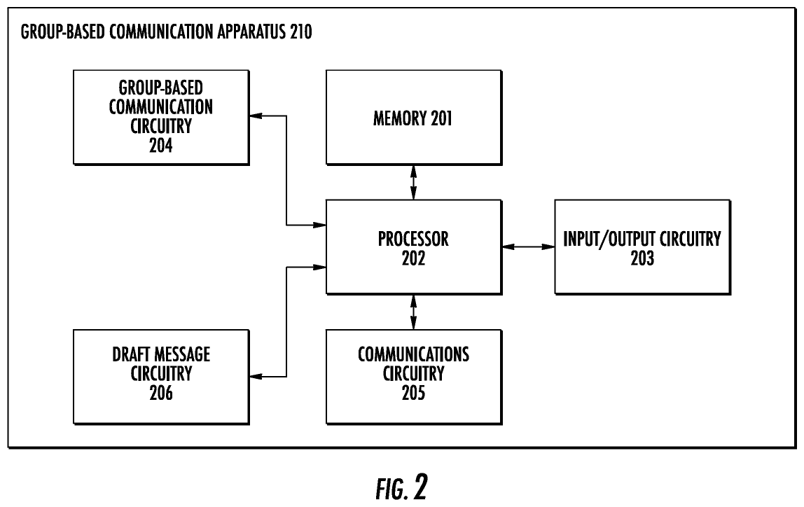

The group-based communication apparatus 210 may be embodied by one or more computing systems, such as group-based communication apparatus 210 shown in FIG. 2. The group-based communication apparatus 210 may include a processor 202, a memory 201, input/output circuitry 203, communications circuitry 205, group-based communication circuitry 204, and draft message circuitry 206. The apparatus 210 may be configured, using one or more of the circuitry 203, 204, 205, and 206 to execute the operations described herein.

Although the components are described with respect to functional limitations, it should be understood that the particular implementations necessarily include the use of particular hardware. It should also be understood that certain of the components described herein may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of the apparatus 210 may provide or supplement the functionality of particular circuitry. For example, the processor 202 may provide processing functionality, the memory 201 may provide storage functionality, the communications circuitry 205 may provide network interface functionality, and the like.

In some embodiments, the processor 202 (and/or co-processor or any other processing circuitry assisting or otherwise associated with the processor) may be in communication with the memory 201 via a bus for passing information among components of the apparatus. The memory 201 may be non-transitory and may include, for example, one or more volatile and/or non-volatile memories. In other words, for example, the memory may be an electronic storage device (e.g., a computer readable storage medium). The memory 201 may be configured to store information, data, content, applications, instructions, or the like, for enabling the group-based communication apparatus 210 to carry out various functions in accordance with example embodiments of the present disclosure.

The processor 202 may be embodied in a number of different ways and may, for example, include one or more processing devices configured to perform independently. Additionally, or alternatively, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 202 may be configured to execute instructions stored in the memory 201 or otherwise accessible to the processor. Alternatively, or additionally, the processor 202 may be configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

As just one example, the processor 202 may be configured to maintain one or more communication channels connecting a plurality of client devices 101A-101N (shown in FIG. 1) to enable message sharing therebetween. The processor 202 ensures that messages intended for exchange between the client devices 101A-101N within the particular communication channel are properly disseminated to those client devices 101A-101N for display within respective display windows provided via the client devices 101A-101N.

Moreover, the processor 202 may be configured to synchronize messages exchanged on a particular communication channel with a database for storage and/or indexing of messages therein. In certain embodiments, the processor 202 may provide stored and/or indexed messages for dissemination to client devices 101A-101N. The processor 202 may also provide to distribute such stored and/or indexed messages across various group-based communication workspaces and associated group-based communication channels as discussed herein.

In some embodiments, the group-based communication apparatus 210 may include input/output circuitry 203 that may, in turn, be in communication with processor 202 to provide output to the user and, in some embodiments, to receive an indication of a user input. The input/output circuitry 203 may comprise a user interface (e.g., a group-based communication interface) and may include a display and may comprise a web user interface, a mobile application, a client device, a kiosk, or the like. In some embodiments, the input/output circuitry 203 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 201, and/or the like).

The communications circuitry 205 may be any means such as a device or circuitry embodied in either hardware or a combination of hardware and software that is configured to receive and/or transmit data from/to a network and/or any other device, circuitry, or module in communication with the group- based communication apparatus 210. In this regard, the communications circuitry 205 may include, for example, a network interface for enabling communications with a wired or wireless communication network. For example, the communications circuitry 205 may include one or more network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s).

The group-based communication circuitry 204 includes hardware and software configured to support a group-based communication system 200. The group-based communication circuitry 204 may utilize processing circuitry, such as the processor 202, to perform these actions. The group-based communication circuitry 204 may send and/or receive data from group-based communication repository 207. In some implementations, the sent and/or received data may be group-based communication objects (e.g., messages, files, links, etc.) organized among a plurality of group-based communication channels. It should also be appreciated that, in some embodiments, the group-based communication circuitry 204 may include a separate processor, specially configured field programmable gate array (FPGA), or application specific interface circuit (ASIC).

The draft message circuitry 206 includes hardware and software configured to support draft messaging communications-related functionality, features, and/or services of the group-based communication system 200. The draft message circuity 206 may utilize processing circuitry, such as the processor 202, to perform these actions. The draft message circuitry 206 may send and/or receive data from group-based communication repository 207 (e.g., the group-based communication suggestions repository). In some implementations, the sent and/or received data may be destination suggestion item(s), destination suggestion set(s), user recipient data, group-based communication thread data, group-based communication channel data user profile data, user role data, user topic data, user organization data, channel data, user interaction data, user identifiers, draft messaging communications, draft message metadata and associated data. It should also be appreciated that, in some embodiments, the draft message circuity 206 may include a separate processor, specially configured field programmable gate array (FPGA), or application specific interface circuit (ASIC).

It is also noted that all or some of the information discussed herein can be based on data that is received, generated and/or maintained by one or more components of the group-based communication apparatus 210. In some embodiments, one or more external systems (such as a remote cloud computing and/or data storage system, one or more external resources 103A-103N) may also be leveraged to provide at least some of the functionality discussed herein.

As described above and as will be appreciated based on this disclosure, embodiments of the present disclosure may be configured as methods, mobile devices, frontend graphical user interfaces, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor or other programmable apparatus's circuitry to produce a machine, such that the computer, processor, or other programmable circuitry that execute the code on the machine creates the means for implementing various functions, including those described herein.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

In various embodiments of the present disclosure, the group-based communication apparatus 210 is configured to receive a compose draft message request comprising a user identifier. In some embodiments, the group-based communication apparatus 210 is configured to cause rendering of a draft message composer interface to a group-based communication interface of the group-based communication system in response to receiving a compose draft message request comprising a user identifier. FIG. 3A depicts an example draft message composer interface 300 structured in accordance with one embodiment of the invention. In this embodiment, the draft message composer interface 300 is rendered in a minimized or compact form, as illustrated in FIG. 3A. In particular embodiments, the compact form of the draft message composer interface 300 is expandable as depicted in FIG. 3B and as explained in more detail below. In still further embodiments, upon a first expansion, the draft message composer interface 300 is rendered as slightly expanded, as depicted in FIG. 3C. In still further embodiments, upon full expansion, the draft message composer interface 300 is rendered to the full-screen such that the dimension of the draft message composer interface 300 fits to the size of the group-based communication interface subject to the sidebar pane (i.e., filling the message pane), as illustrated in FIG. 3D. In one embodiment, the draft message composer interface 300 is rendered in the minimized or compact form by default. In another embodiment, the draft message composer interface 300 is rendered in a slightly expanded form, as depicted in FIG. 3C, by default, In still alternative embodiments, the draft message composer interface 300 is rendered as full-screen by default. Such depictions, however, are for purposes of illustration and not of limitation and other suitable variations of the dimensions of the draft message composer interface 300, such as dimensions less than a full expansion form and more than a compact form, are also contemplated by this disclosure as will be apparent to one of ordinary skill in the art.

In each embodiment of the draft message composer interface 300, the draft message composer interface 300 is rendered in response to receipt of the compose draft message request. In some embodiments, the draft message composer interface 300 is revealed and/or accessed once a user clicks on a compose interface element 306 rendered to the group-based communication interface. In some embodiments, the compose interface element 306 is a pencil icon button rendered to the sidebar pane of the group-based communication interface as depicted in FIGS. 3A-3C. In other embodiments, the compose interface element 306 is a “+Compose” button rendered to the sidebar pane of the group-based communications interface as depicted in FIG. 3D. The pencil icon button in FIGS. 3A-3C and the “+Compose” button in FIG. 3D are each depicted as a representative button or executable element right-aligned or center-aligned in the lower perimeter of the sidebar pane. Such depictions, however, are for purposes of illustration and not of limitation and other suitable variations of the compose interface element 306, such as “New Message” or in other locations of the sidebar pane or the group-based communication interface, are also contemplated by this disclosure as will be apparent to one of ordinary skill in the art.

In some embodiments, the group-based communication interface comprises a plurality of “panes” such that the group-based communication interface is divided into two or more panes. In such embodiments, the group-based communication apparatus is configured to render a plurality of panes to the group-based communication interface. In such instances, the plurality of panes are configured to be viewable simultaneously within a defined window display of the group-based communication interface. For example, the depicted group-based communication interface in FIGS. 3A-3D is divided into two panes, a first pane (e.g., a message pane) and a second pane (e.g., a sidebar pane), which are viewable simultaneously within the defined window display of the group-based communication interface. In some embodiments, the conversation feed associated with a group-based communication channel is rendered to the first pane (i.e., the message pane) when the user is accessing the group-based communication system via a group-based communication channel interface.

In particular embodiments, the group-based communication apparatus is further configured to render the compose interface element to the second pane of the plurality of panes, i.e., a different pane than the message pane, as depicted in FIGS. 3A-3D. That is, the compose interface element is depicted as being rendered to the sidebar pane in FIGS. 3A-3D. In still further embodiments, the compose interface element is configured to be selectable by a user. That is, the compose interface element 306 is a user engageable element that is configured to render the draft message composer interface 300 in response to a user selection of, or upon user engagement with, the compose interface element 306. The depicted draft message composer interface 300 is rendered to the first pane, i.e., the message pane portion, of the group-based communication interface upon engagement with the compose interface element 306. As such, the compose interface element 306 is rendered to a different pane (i.e., the second pane or sidebar pane) than the first pane (i.e., the message pane), such that the compose interface element 306 is not associated with a specific group-based communication channel or a specific group-based communication channel interface.

Returning to FIG. 3A, the depicted draft message composer interface 300 comprises a destination input component 303 and a draft content input component 304. The destination input component 303 is configured for, among other things, optional user entry of a destination input as explained in more detail below. The draft content input component 304 is configured for optional user entry of draft body content data. In the compact form of the draft message composer interface 300, the draft content input component 304 is rendered, in some embodiments, as a single line to the group-based communication interface, as depicted in FIG. 3A. As explained herein, in particular embodiments, the draft content input component 304 is expandable such that it can be expanded by clicking or selecting an expand interface element 330. In such embodiments, an expand interface element 330 is rendered and accessible upon detecting that the user is “hovering” over the draft content input component 304. For example, in FIG. 3B, the expand interface element 330 is rendered to the side of the draft content input component 304 upon detection of such “hovering” by the user. In still other embodiments, upon detection of the user's selection of the expand interface element 330, the group-based communication apparatus 210 causes rendering of a slightly expanded draft content input component 304 and the expand interface element 330 is rendered inline with the draft content input component 304, as depicted in FIG. 3C. In some embodiments, the slightly expanded draft content input component 304 is rendered with a formatting bar, providing the user with additional formatting options, as depicted in FIG. 3C. In other embodiments, the slightly expanded draft content input component 304 is not rendered with a formatting bar. In still further embodiments, upon detection of the user's selection of the expand interface element 330, the group-based communication apparatus 210 causes rendering of a fully-expanded draft content input component 304 (with or without a formatting bar) and the expand interface element 330 is rendered inline and to the corner of the draft content input component 304, as depicted in FIG. 3D.

In still further embodiments, the draft content input component 304 further includes an attach object component 305, which is configured to allow a user to indicate that the user wishes to attach one or more objects (i.e., file attachments) to the draft messaging communication associated with the draft message composer interface 300. The attach object component 305 in FIG. 3A is depicted as a user-engageable paperclip icon. In some embodiments, the attach object component 305 is rendered as inline with the draft content input component 304, i.e., as illustrated in FIG. 3A. In other embodiments, the attach object component 305 is rendered as inline with the formatting bar of the draft content input component 304, i.e., as illustrated in FIG. 3C.

Upon detection of user engagement with the attach object component 305, in some embodiments, the group-based communication apparatus 210 initiates an attachment process and causes rendering of such attachment(s) to the group-based communication interface. In some embodiment, such attachment(s) are depicted as an inline file attachment. That is, each attachment is depicted as part of or inside the draft message composer interface 300 as the attachment is appended to the text block of the draft messaging communication such that the text block scrolls as a singular object. In such embodiments, attaching files corresponds to having draft message content. In other embodiments, the attachment(s) are depicted in a box separate, apart, and beneath the draft message composer interface 300. In still further embodiments, the draft message composer interface 300 is further configured to allow the user to “drag-and-drop” files into the vicinity of the rendered draft message composer interface 300 to indicate that the user wishes to attach such one or more objects to the draft messaging communication.

In some embodiments, the draft message composer interface 300 further comprises a “Send Message” or “Send” element or button 325, which is configured to allow the user to indicate that the user wishes to send or post the draft message (i.e., convert the draft messaging communication to a messaging communication) to another user, a group-based communication thread, or a group-based communication channel. In still further embodiments, it is contemplated that the “Send” element or button 325 is disabled or inactive while either of the destination input component 303 or the draft content input component 304 is empty. In such embodiments, the “Send” element or button 325 is enabled or active in the instance where both the destination input component 303 and the draft content input component 304 comprise valid content. The “Send” element or button 325 in FIG. 3A is depicted as a representative button or executable element with an arrow symbol, however, such depiction is for purposes of illustration and not of limitation and other suitable variations of the “Send” element are also contemplated by this disclosure as will be apparent to one of ordinary skill in the art.

In still further embodiments, it is contemplated that the “Send” element or button 325 is configured to allow the user to indicate or select a date and/or time to send or post the draft messaging communication. For example, in some instances, the user may wish to send or post the draft messaging communication immediately. In other instances, the user may wish to send or post the draft messaging communication at a specified time in the future. In such instances, the “Send” element or button 325 is configured to allow the user to specify such future time entry or timestamp for posting.

It is also contemplated that the group-based communication apparatus 210 is configured to provide the user with context to determine where or when a draft messaging communication should be posted in a group-based communication channel, group-based communication thread, or direct message conversation. For example, a draft messaging communication may be composed at a point in time different from when it is eventually posted to its intended destination. In the passage of time from composition to posting, other messages may have been posted to the conversation flow in a group-based communication channel, group-based communication thread, or direct message conversation feed, rendering the posting of the draft messaging communication out of place or out of context. Therefore, in some embodiments, the draft message composer interface 300 comprises a context view or a preview interface element allowing the user to preview the channel conversation flow, thread conversation flow, or direct message conversation flow, for context before posting the draft messaging communication. In some embodiments, when a destination input is selected and the selected destination has a history of messages or conversation feed, the group-based communication apparatus 210 automatically or programmatically causes rendering of the history of messages or conversation feed in a context view to the draft message composer interface 300. For example, in embodiments wherein the draft message composer interface 300 is rendered in compact form, such as depicted in FIG. 3A, the context view which provides the user with context in the conversation feed of the selected destination is rendered to the draft message composer interface 300 in between the destination input component 303 and the draft content input component 304. In some embodiments, the context view appears much like the conversation feed in the selected destination itself. In particular embodiments, the context view is rendered only upon user engagement with a preview interface element (not depicted), which may depicted by a representative button or other executable element that the user may click or otherwise indicate selection of the preview interface element. For example, in an embodiment wherein the draft message composer interface 300 is rendered to the full-screen, the preview interface element is rendered to optionally allow for context view upon user selection.

In other embodiments, the group-based communication apparatus 210 is configured to manage a group-based communication interface of the group-based communication system. In such embodiments, similar to embodiments as discussed herein, the group-based communication apparatus 210 is configured to receive a compose draft message request comprising a user identifier and cause rendering of a draft message composer interface 300 to the group-based communication interface of the group-based communication system in response to receipt of the compose draft message request. Similar to some other embodiments described herein, the draft message composer interface 300 comprises a destination input component 303 and a draft content input component 304. The draft message composer interface 300 is associated with a draft messaging communication. That is, the user's interaction with the draft message composer interface 300 forms the draft messaging communication.

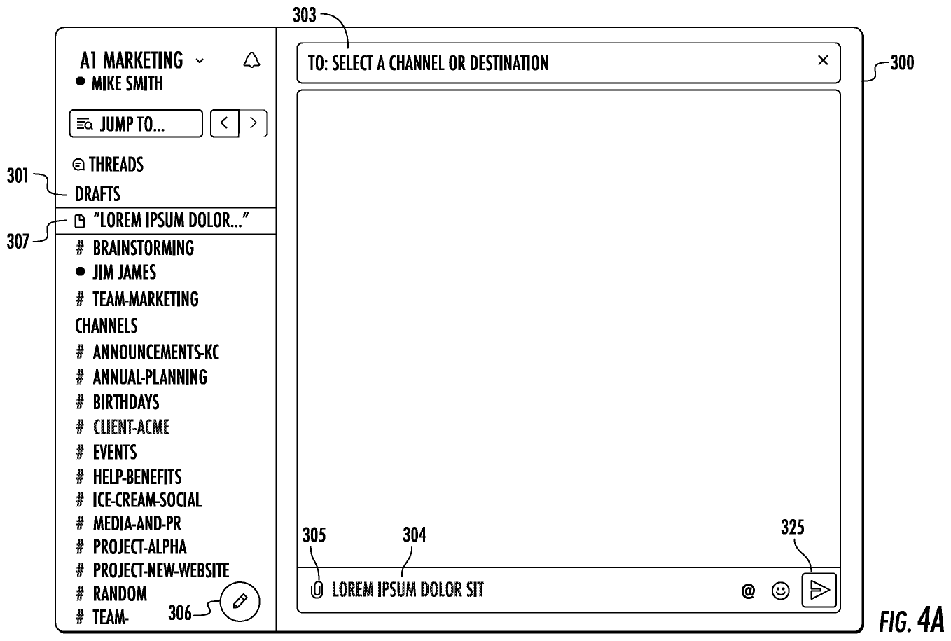

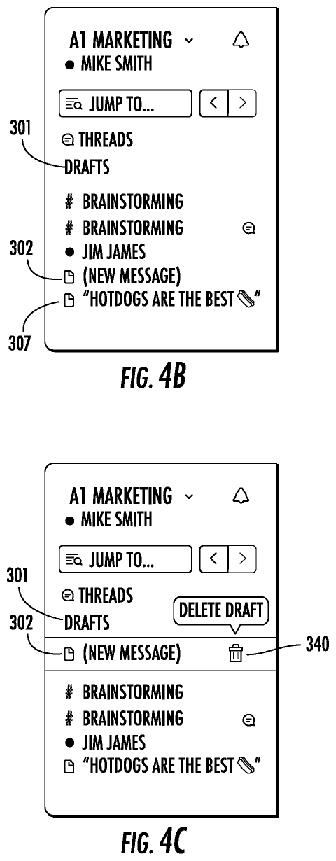

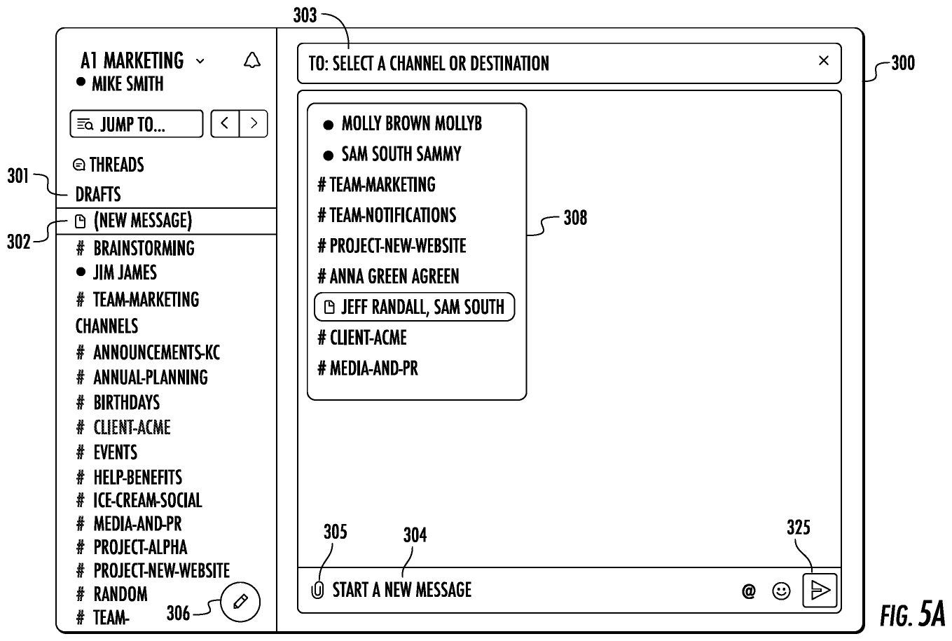

Returning to the compose draft message request, the group-based communication apparatus 210 is further configured to cause rendering of a draft message placeholder 302 as a new row in a drafts section 301 of a sidebar pane of the group-based communication interface as illustrated in FIG. 3A. In some embodiments, the draft message placeholder 302 is associated with the draft messaging communication of the draft message compose interface 300. In still further embodiments, the group-based communication apparatus 210 is configured to assign a draft message title 307 to the draft messaging communication and automatically update the drafts section 301 of the sidebar pane of the group-based communication interface to replace the draft message placeholder 302 with the assigned draft message title 307. In some embodiments, assigning the draft message title 307 to the draft messaging communication comprises detecting user entry (i.e., a keystroke engagement) of the draft content input component 304 of the draft message composer interface 300 and assigning at least a portion of the detected user input (i.e., detected keystroke engagement) as the draft message title 307 of the draft messaging communication. That is, in some embodiments, user entry, detected user input, or keystroke engagement in the draft content input component 304 not only becomes the draft body content data of the draft messaging communication, but also is assigned as the draft message title 307. In some embodiments, once an assigned draft message title 307 is available, the draft message title 307 is rendered to the drafts section 301 of the sidebar pane, replacing the draft message placeholder 302, as depicted in FIG. 4A. In such embodiments, unless and until such keystroke engagement is detected, the group-based communication apparatus 210 is configured to continue to cause rendering of the draft message placeholder 302. The rendering of the draft message placeholder 302 as illustrated in FIGS. 3A-3D indicates “(New Message)”, however, such depiction is for purposes of illustration and not of limitation and other suitable variations of the draft message placeholder 302 are also contemplated by this disclosure as will be apparent to one of ordinary skill in the art.

In other embodiments, the draft message title 307 is assigned based on the user's interaction with the draft message composer interface 300. That is, while the draft message composer interface 300 is rendered to the group-based communication interface, the group-based communication apparatus 210 detects user input (i.e., keystroke engagement) in the destination input component 303. In some embodiments, at least a portion of such user entry or detected keystroke embodiment in the destination input component 303 is assigned as the draft message title 307 of the draft messaging communication. For example, in response to keystroke engagement detected in the destination input component 303 (or a first destination selection indication generated upon user selection engagement of a suggested group- based communication channel or group-based communication thread in the destination suggestion interface 308 as discussed below), the identified or selected group-based communication channel or group-based communication thread is assigned as the draft message title 307. In another example, in response to keystroke engagement in the destination input component 303 (or a first destination selection indication generated upon user selection engagement of one or more user recipients in the destination suggestion interface 308 as discussed herein), the identified or selected user recipient(s) is assigned as the draft message title 307. Upon assigning the draft message title 307 based on the user's interaction with the destination input component 303, the group-based communication apparatus 210 is configured to automatically update the sidebar pane of the group-based communication interface to replace the draft message placeholder 302 with the assigned draft message title 307. In instances where a draft message title 307 has not been assigned to a draft messaging communication, the draft message placeholder 302 continues to be rendered to the drafts section 301 of the sidebar pane.

Thus, in some embodiments, the draft messaging communication comprises the keystroke engagement detected in either the draft content input component 304 or the destination input component 303 and the assigned draft message title 307. In some embodiments, the rendering of the draft message title 307 is limited by the width dimension of the sidebar pane and only a portion of the draft content input component 304 is assigned as the draft message title 307, and the remainder being truncated in accordance with that width. For example, in some embodiments, the assigned draft message title 307 is limited to a specific number of characters, e.g., 24, associated with the width of the sidebar pane. In still further embodiments, the draft messaging communication further comprises an author identifier corresponding to the user identifier.

In still further embodiments, it is contemplated that assigning channels or user recipients as a draft message title 307 is reserved for those draft messaging communications that are “attached” or “active” such that the draft messaging communication originates from the group-based communication channel interface, group-based communication thread, or the direct message interface. In such embodiments, “unattached” or “inactive” direct messaging communications are assigned draft message titles 307 based upon user entry (i.e., keystroke engagement or attached objects) in the draft content input component 304, regardless of user input in the destination input component 303, thereby distinguishing “attached” and “unattached” draft messaging communications in the drafts section 301 of the sidebar pane.

In some embodiments, the draft message title(s) 307 and the draft message placeholder(s) 302 depicted in the sidebar pane each comprise a user engageable link configured to allow access to the selected draft messaging communication upon user selection engagement of the user engageable link. In some embodiments, upon user selection engagement, the group-based communication apparatus 210 causes rendering of the selected draft messaging communication in the draft message composer interface 300. In still further embodiments, the draft message title(s) 307 and the draft message placeholder(s) 302 depicted in the sidebar pane each comprise a user engageable link configured to allow access to the selected draft messaging communication upon user selection engagement of the user engageable link. In some embodiments, upon user selection engagement, the group-based communication apparatus 210 causes rendering of the selected draft messaging communication in the group-based communication channel interface, group-based communication thread interface, or direct message interface, depending on the type of draft messaging communication. In some embodiments, it is contemplated that the origination source of the draft messaging communication determines the type of user engageable link associated with the draft messaging communication. For example, in those embodiments in which the group-based communication apparatus 210 is configured to cull all draft messaging communications associated with a user identifier, regardless of source, the user engageable link of an “attached” draft messaging communication is configured to allow access to the selected draft messaging communication in a group-based communication channel interface, group-based communication thread interface, or direct message interface, while the user engageable link of an “unattached” draft messaging communication is configured to allow access to the selected draft messaging communication in the draft message composer interface 300.

In some embodiments, the drafts section 301 of the sidebar pane comprises rendering of a plurality of draft message placeholders and a plurality of draft message titles associated with a plurality of draft messaging communications. The rendering of the draft message titles 307 and the draft message placeholders 302 to the drafts section 301 of the sidebar pane may contain any one or more characters (e.g., alphanumeric characters or emojis). Additionally and/or alternatively, in some embodiments, the rendering of the draft message titles 307 and the draft message placeholder 302 to the drafts section 301 of the sidebar pane depicts what type of draft messaging communication with which it is associated, as illustrated in FIG. 4B. For example, in some embodiments, the rendering of a “#” and draft message title is associated with an a draft messaging communication “attached” to a group-based communication channel (i.e., the draft messaging communication originated from a group-based communication channel interface as opposed to the draft message composer interface 300). In still further embodiments, the rendering of a “#”, a draft message title, and a right-aligned conversation bubble icon is associated with an a draft messaging communication “attached” to a group-based communication thread (i.e., the draft messaging communication originated from a group-based communication thread interface as opposed to the draft message composer interface 300). In still further embodiments, the rendering of a circular dot icon and one or more user recipients is associated with a draft messaging communication “attached” to a direct message conversation (i.e., the draft messaging communication originated from a group-based communication direct messaging interface as opposed to the draft message composer interface 300). In still further embodiments, the rendering of a paper icon with “(New Message)” is associated with an “unattached” draft messaging communication without any draft body content (i.e., the draft messaging communication originated from the draft message composer interface 300). In still further embodiments, the rendering of a paper icon with a draft message title 307 is associated with an “unattached” draft messaging communication with draft body content (i.e., the draft messaging communication originated from the draft message composer interface 300).

Still further, the rendering of the draft message titles 307 and the draft message placeholders 302 as rows in the drafts section 301 of the sidebar pane may be ordered in a myriad of ways. In one embodiment, the group-based communication apparatus 210, via the draft message circuitry 206, causes ordering of the display of the draft messaging communications based on the alphabetical sequence of the draft message titles of the draft messaging communication. In other embodiments, the display of the draft message titles 307 and the draft message placeholders 302 (a.k.a., the draft messaging communications) is ordered based on the last edit timestamp associated with each draft messaging communication. For example, in some instances, the draft messaging communications are ordered chronologically based on the last edit timestamp. In other instances, the draft messaging communications are ordered reverse chronologically based on the last edit timestamp such that draft message title 307 or draft message placeholder 302 corresponding to the draft messaging communication that was edited or created most recently is displayed first or at the top of the drafts section 301. Other variations of ordering the draft messaging communications in the drafts section 301 of the sidebar pane are also contemplated by this disclosure as will be apparent to one of ordinary skill in the art. Further, as discussed in more detail below with respect to the drafts view interface 320, in some embodiments, regardless of the origination source of the draft messaging communication, the group-based communication apparatus 210 is configured to cause rendering of all draft messaging communications to the drafts section 301 of the sidebar pane.

It is further contemplated that in some embodiments, the drafts section 301 is collapsible such that when the group-based communication apparatus 210 receives an indication from the user that an icon associated with the drafts section 301, such as a chevron icon (not pictured), has been clicked or otherwise selected by the user, each of the rows rendered in the drafts section 301 corresponding to a draft messaging communication, collapses or disappears from the sidebar pane. In still further embodiments, it is contemplated that the drafts section 301 is configured to render a number corresponding to the number of pending draft messaging communications. For example, if the rendering of the drafts section 301 comprises three rows corresponding to three draft messaging communications, in response to receiving a collapse command from the user (i.e., as a result of the user clicking on a collapse icon associated with the drafts section 301), the group-based communication apparatus 210 is configured to collapse or stop rendering the individual rows corresponding to the draft messaging communications and automatically update the rendering of the drafts section 301 to include the number “3”.

In still further embodiments, the group-based communication apparatus 210 is configured to detect a user “hovering” over a row in the drafts section 301 of the sidebar pane. In some embodiments, upon detecting such “hovering,” the group-based communication apparatus 210 is configured to render a user-engageable delete interface element 340 in association with the row, i.e., in association with the draft message placeholder 302 or draft message title 307, over which the user is “hovering.” In some embodiments, upon detection of user selection engagement of the delete interface element 340, the group-based communication apparatus 210 is configured to stop rendering the associated draft message placeholder 302 or draft message title 307 and delete the associated draft messaging communication. In still further embodiments, the group-based communication apparatus 210 is configured to stop rendering the associated draft message placeholder 302 or draft message title 307, delete the associated draft messaging communication, and further clear the rendering of the associated draft messaging communication from the message input component of a group-based communication channel interface. For example, in response to detecting a user selection engagement of the delete interface element 340 associated with an “attached” draft messaging communication (i.e., a draft messaging communication originating from a group-based communication channel interface, group-based communication thread interface, or direct messaging interface), the group-based communication apparatus 210 is configured to clear the contents of such message input component of the associated group-based communication channel interface. In still further embodiments, it is contemplated that the draft messaging communication would not be deleted instantly or immediately, and instead the group-based communication apparatus 210 is configured to render an user-engageable undo deletion interface element (not depicted) for a limited period of time to allow the user to restore the draft messaging communication. Upon expiration of the limited period of time, e.g., three seconds, without detection of selection or engagement by the user of the undo deletion interface element, the group-based communication apparatus 210 is configured to delete the selected draft messaging communication. The delete interface element 340 in FIG. 4C is depicted as a trash icon button or executable element, however, such depiction is for purposes of illustration and not of limitation and other suitable variations of the delete interface element 340 are also contemplated by this disclosure as will be apparent to one of ordinary skill in the art.

In some embodiments, the group-based communication apparatus 210 is configured to query a group-based communication repository, i.e., the group-based communication drafts repository, for all draft messaging communication associated with a user identifier and the current group identifier associated with the workspace with which the user is accessing the group-based communication system. In other embodiments, the group-based communication apparatus 210 is configured to query the group-based communication drafts repository for all draft messaging communications associated with the user identifier, regardless of the current group identifier. In such embodiments, the group-based communication drafts repository returns all drafts associated with the user identifier, without limitation to group identifiers associated with the user identifier. In such embodiments, the user identifier may be associated with a plurality of group-based communication workspaces in addition to the current group identifier, i.e., one or more additional group identifiers. As such, in some embodiments, the draft messaging communications returned by the query comprise one or more draft messaging communications associated with the one or more additional group identifiers. For example, the user may be accessing the group-based communication system via a group-based communication interface associated with one group-based communication workspace. Rather than requiring the user to close the current group-based communication workspace or interface or switch to a different group-based communication workspace or interface with which the user is associated, the group-based communication apparatus 210 determines and renders all draft messaging communications to the group-based communication interface (i.e., with draft message titles 307 and draft message placeholders 302 in the drafts section 301 and/or in response to receipt of a drafts view request. In such instances, the results are not limited to just the current workspace within which the user is accessing the group-based communication system.

In some embodiments, the group-based communication apparatus 210 is configured to cause storage and rendering of a limited number of draft messaging communications such that in some embodiments, the group-based communication apparatus 210 causes rendering of an alert or error message to the group-based communication interface in response to receiving a compose draft message request in excess of a predetermined threshold, e.g., 100, of draft messaging communications. For example, in some embodiments, the group-based communication apparatus 210 renders an alert or error message indicating that the user has reached the draft limit, i.e., predetermined threshold. In further embodiments, the group-based communication apparatus 210 is configured to render an instruction to the group-based communication interface to delete one or more draft messaging communications in order to compose a new draft messaging communication. In still other embodiments, the group-based communication apparatus 210 is configured to disable the compose interface element 306 in addition to or instead of rendering the alert or error message.

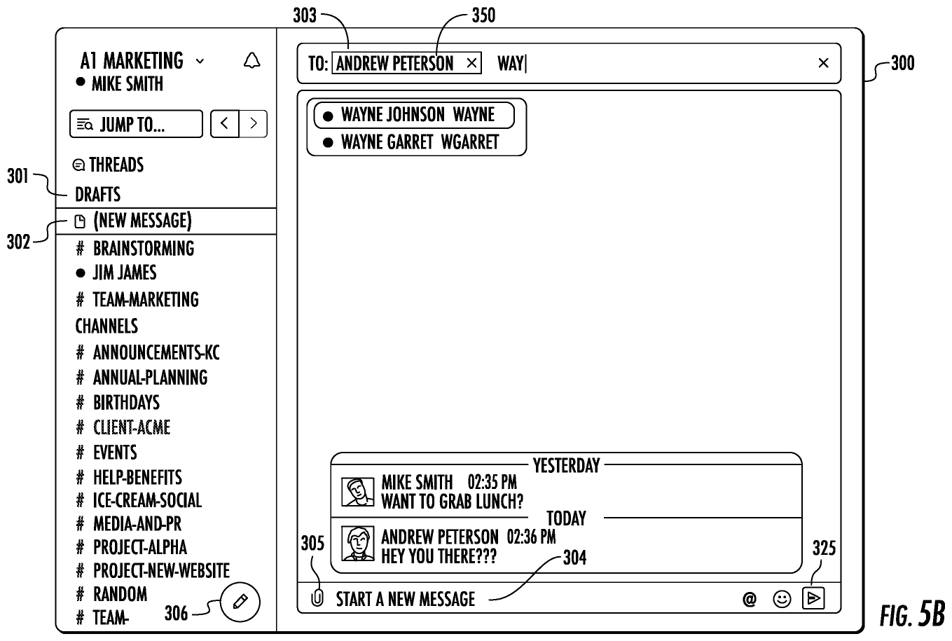

In some embodiments, the group-based communication apparatus 210 is configured to determine and render suggested destination items in response to detecting an engagement of the destination input component 303. That is, while the draft message composer interface 300 is rendered to the group-based communication interface, the group-based communication apparatus 210, through the draft message circuitry 206, is configured to detect an engagement of the depicted destination input component 303 as illustrated in FIG. 5A. More particularly, engagement of the destination input component 303 by the user creates a destination suggestion command and causes the draft message circuitry 206 to determine a destination suggestions set for association with the destination suggestion command. In the depicted embodiment of the destination input component 303 of FIG. 5A, the detected engagement is a non-keystroke engagement, however, such depiction is for purposes of illustration and not of limitation and other suitable engagements (i.e., keystroke engagement) are also contemplated by this disclosure as will be apparent to one of ordinary skill in the art.

In some embodiments, the group-based communication apparatus 210 is configured to determine a first destination suggestions set by querying a group-based communication suggestions repository based upon at least the user identifier and further cause rendering of the first destination suggestions set to a destination suggestion interface 308, as depicted in FIG. 5A. In some embodiments the group-based communication suggestions repository comprises user recipient data, group-based communication thread data, and group-based communication channel data. As such, in some embodiments, the queried destination suggestion items are culled from user recipient data, group-based communication thread data, and group-based communication channel data stored in the group-based communication suggestions repository. Such destination suggestion items may include any one or more of public channel(s), private channel(s), thread(s), direct message conversations, and group or multiple party direct message conversations. For example, returning to FIG. 5A, the group-based communication apparatus 210 detects a non-keystroke engagement of the destination input component 303, determines a first destination suggestions set by querying the group-based communication suggestion repository based on at least the user identifier, and causes rendering of a destination suggestion interface 308 comprising the first destination suggestions set. The first destination suggestions set depicted in FIG. 5A comprises suggested destinations of different types. That is, the depicted first destination suggestions set comprises multiple suggested user recipients and multiple suggested group-based communication channels. For instance, the first two items depicted with a dot are individual user recipients with which the user may select to initiate a direct messaging conversation. The next three items depicted with a hashtag symbol (“#”) are individual group-based communication channels which the user may select to post a messaging communication. The seventh item depicts two user recipients corresponding to a multiple person direct message (“MPDM”) conversation. That is, one user recipient corresponds to a direct message conversation and two or more recipients corresponds to a MPDM conversation. Though not depicted, in some embodiments, the first destination suggestions set includes one or more suggested group-based communication threads. As such, in some embodiments, the first destination suggestions set comprises one or more suggested user recipients, one or more suggested group-based communication threads, one or more suggested group-based communication channels, or combinations thereof, as depicted in FIG. 5A.

In particular embodiments, the destination suggestion interface 308 is configured for user selection engagement such that a first destination selection indication is generated upon user selected engagement of at least one destination suggestion item of the first destination suggestions set. For example, in FIG. 5A, the seventh destination suggestion item depicted corresponds to two user recipients, Jeff Randall and Sam Smith, in a MPDM conversation. The names are highlighted and user selection engagement by the user includes clicking on, touching, or otherwise selecting one of the selectable destination suggestion items. In response to such user selection engagement, a first destination selection indication is generated.

Additionally and/or alternatively, the draft message circuitry 206 is configured to receive user input of a destination entered in the destination input component 303 of the draft message composer interface by a myriad of ways. In one example, the user can manually provide user input comprising one or more keystrokes directly in and/or keystroke engagement of the destination input component 303 without selecting one of the suggested destination items. That is, the group-based communication apparatus 210 is configured to receive user entry of a first destination input in the destination input component 303 such that one or more keystroke entries are received in the destination input component 303. In such embodiments, a first destination selection indication is generated upon receipt of a completion keystroke, such as the user selecting “Enter” or “Return.”

Returning to the destination suggestion interface 308, in some embodiments, in response to the receipt of the first destination selection indication, the group-based communication apparatus 210, via the draft message circuitry 206, determines whether the first destination selection indication corresponds to a group-based communication channel or to one or more user recipients. More particularly, receipt of such an indication creates a destination type determination command and causes the draft message circuitry 206 to determine whether the first destination selection indication corresponds to a group-based communication channel or to one or more recipients.

For example, in an instance whereupon it is determined that the first destination selection indication corresponds to a group-based communication channel, the group-based communication apparatus 210, via the draft message circuitry 206, causes rendering in the destination input component 303 of a channel title tile associated with the selected group-based communication channel. A channel title tile is a user interface component rendered to the destination input component 303 comprising a display of the channel title associated with the selected group-based communication channel in association with a user engageable deletion element. In some embodiments, the user engageable deletion element is depicted as an “X” or a trash icon executable element associated with the display of the channel title. In some embodiments, upon detection of user selection engagement of the user engageable deletion element, the group-based communication apparatus 210 is configured to stop rendering the associated channel title tile to the destination input component. Such channel title tiles improve the functionality of the interface with respect to all types of consumer devices and may especially be optimized for rendering to mobile consumer devices. In still other embodiments, the group-based communication apparatus 210 is further configured to allow the user to further identify and select a group-based communication thread associated with the selected group-based communication channel For example, upon determination that the first destination selection indication corresponds to a group-based communication channel, the group-based communication apparatus 210 is configured to render a list of group-based communication threads for further selection. In some embodiments, the list contains all group-based communication threads associated with the selected group-based communication channel In other embodiments, the destination input component 303 is configured to receive further user entry to provide certain suggested group-based communication threads. For example, in some embodiments, user entry of one or more user recipients after a first destination selection indication associated with a group-based communication channel will cause rendering of a list containing all threads associated with the selected group-based communication channel wherein the user recipient is a member of such thread. Additionally and/or alternatively, suggested group-based communication threads are determined based on a last edit timestamp associated with the group-based communication thread. In such embodiments, the group-based communication apparatus 210 is configured to cause rendering in the destination input component 303 of a thread title tile upon receipt of a further user entry selecting the group-based communication thread. Similar to a channel title tile, a thread title tile is a user interface component rendered to the destination input component 303 comprising a display of the thread title associated with the selected group-based communication thread in association with a user engageable deletion element. In some embodiments, the user engageable deletion element is depicted as an “X” or a trash icon executable element associated with the display of the thread title. In some embodiments, upon detection of user selection engagement of the user engageable deletion element, the group-based communication apparatus 210 is configured to stop rendering the associated thread title tile to the destination input component. Such thread title tiles improve the functionality of the interface with respect to all types of consumer devices and may especially be optimized for rendering to mobile consumer devices.

In still further embodiments, the first destination suggestions set comprises one or more suggested group-based communication threads without requiring additional user entry from the user in order to select a group-based communication thread. In such embodiments, the group-based communication apparatus 210 is configured to determine whether the first destination selection indication corresponds to a group-based communication channel, a group-based communication thread, or to one or more user recipients, which does not require the user to provide additional information to select a group- based communication thread. In such instances, selection of the group-based communication thread and determination that the selected destination item is associated with the group-based communication thread cause rendering in the destination input component 303 of a thread title tile associated with the selected group-based communication thread.

Additionally and/or alternatively, determination of the destination type is required in some embodiments. For example, in some embodiments, upon determination that the first destination selection indication corresponds to a group-based communication channel, the group-based communication apparatus 210 is configured to render an alert or error message to the group-based communication interface upon receipt of a second destination selection indication of an additional group-based communication channel. That is, when a user tries to select two or more group-based communication channels to the destination input component 303, the group-based communication apparatus renders an alert or error message indicating that there are too many channels. In still further embodiments, the group-based communication apparatus 210 is configured to delete a group-based communication channel from the destination input component 303 upon receipt of a deletion selection by the user.

Additionally and/or alternatively, in some embodiments, determination of the destination type is required as the draft message circuitry 206 is configured to facilitate or prevent keystroke engagement in the destination input component 303, depending on the type of the first destination selection indication. In either instance wherein the group-based communication apparatus 210 determines that the first destination selection indication corresponds to a group-based communication channel or a group-based communication thread, the group-based communication apparatus 210 configures the destination input component to prevent keystroke engagement of the destination input component 303. As a result of such a configuration, the selected group-based communication channel or selected group-based communication thread is the only channel or thread to which the draft message eventually may be posted. The selected group-based communication channel or thread may be deleted or replaced, however, only one group-based communication channel or thread is allowed to be selected or inputted in the destination input component 303.

In an instance whereupon it is determined that the first destination input corresponds to one or more user recipients, the group-based communication apparatus 210, via the draft message circuitry 206, causes rendering of a user identifier tile associated with each user recipient of the one or more selected user recipients in the destination input component 303. Similar to a channel title tile and thread title tile, a user identifier tile 350 is a user interface component rendered to the destination input component 303 comprising a display of the user identifier associated with each user recipient of the one or more selected user recipients in association with a user engageable deletion element. In some embodiments, the user engageable deletion element is depicted as an “X” (as depicted by the user identifier tile 350 in FIG. 5B) or a trash icon executable element associated with the display of the channel title. In some embodiments, upon detection of user selection engagement of the user engageable deletion element, the group-based communication apparatus 210 is configured to stop rendering the associated user identifier tile(s) 350 to the destination input component. Such user identifier tiles 350 improve the functionality of the interface with respect to all types of consumer devices and may especially be optimized for rendering to mobile consumer devices.

In still further embodiments, the group-based communication apparatus 210 further configures the destination input component 303 to facilitate a keystroke engagement of the destination input component 303 corresponding to one or more additional selected user recipients. That is, a determination that the first destination selection indication (or user entry of a destination) corresponds to one or more selected user recipients prevents user entry of multiple different types (i.e., a user is not allowed to input a group-based communication channel in addition to the user recipient(s)) of destinations. As such, the destination input component 303 is configured to facilitate user recipient-only entries.

In still further embodiments, the group-based communication apparatus 210 is configured to further determine an additional user recipient suggestions set and automatically update the destination suggestion interface 308 to replace the first destination suggestions set with the additional user recipient suggestions set. The additional user recipient suggestions set comprises one or more additional user recipient suggestions. For example, in FIG. 5B, the first destination selection indication corresponds to the user identifier “Andrew Peterson” which has been rendered to the destination input component 303. As illustrated in FIG. 5B, the draft message circuitry 206 automatically updates the destination suggestion interface 308 to replace the first destination suggestions set with the additional user recipient suggestions set. The depicted additional user recipient suggestions set in FIG. 5B comprises two suggested additional user recipients. As such, the destination input component 303 is configured to facilitate user recipient-only auto-complete suggestions.

In some embodiments, such additional user recipient suggestions are culled from a query of the group-based communication suggestions repository. In still other embodiments, determining the additional user recipient suggestions set is based upon at least the user identifier associated with the compose draft message request and the first destination selection indication. For example, if the user corresponds frequently with the selected user recipient corresponding to the first destination selection indication and another specific additional user recipient, one of the additional user recipient suggestion items is the specific additional user recipient. In another illustrative example, in an instance wherein a MPDM conversation already exists which comprises the user recipient identified by the first destination selection indication and a second additional user recipient as members, the draft message circuitry 206 will, in some embodiments, determine and identify the second additional user recipient as a suggested additional user recipient. Utilizing other data items in addition to or associated with the user identifier to perform the determination is discussed in more detail below.

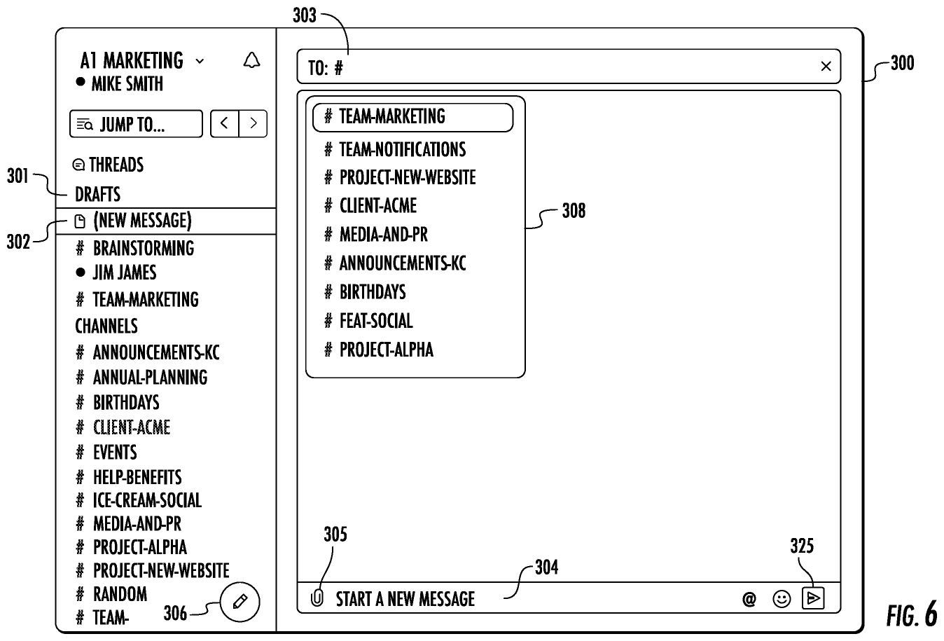

As discussed herein, in some embodiments, the group-based communication apparatus 210 is configured to detect a non-keystroke engagement of the destination input component 303 and in response, determine a first destination suggestions set and cause rendering of such first destination suggestions set to the destination suggestion interface 308. Additionally or alternatively, in some embodiments, the group-based communication apparatus 210 is configured to detect a first keystroke engagement of the destination input component 303, determine a second destination suggestions set, and automatically update the destination suggestion interface 308 to replace the first destination suggestions set with the second destination suggestions set. In particular embodiments, the group-based communication apparatus 210 determines the second destination suggestions set by querying the group-based communication suggestions repository based upon at least the user identifier and the detected first keystroke engagement. For example, in FIG. 6, the detected first keystroke engagement of the destination input component 303 comprises a group-based communication channel indicator (i.e., a keystroke entry of a hashtag) and, as a result, the depicted second destination suggestions set comprises multiple suggested group-based communication channels. It is contemplated that in some embodiments, the detected keystroke engagement of the destination input component 303 comprises a group-based communication thread indicator and, as a result, the second destination suggestions set comprises multiple suggested group-based communication threads.

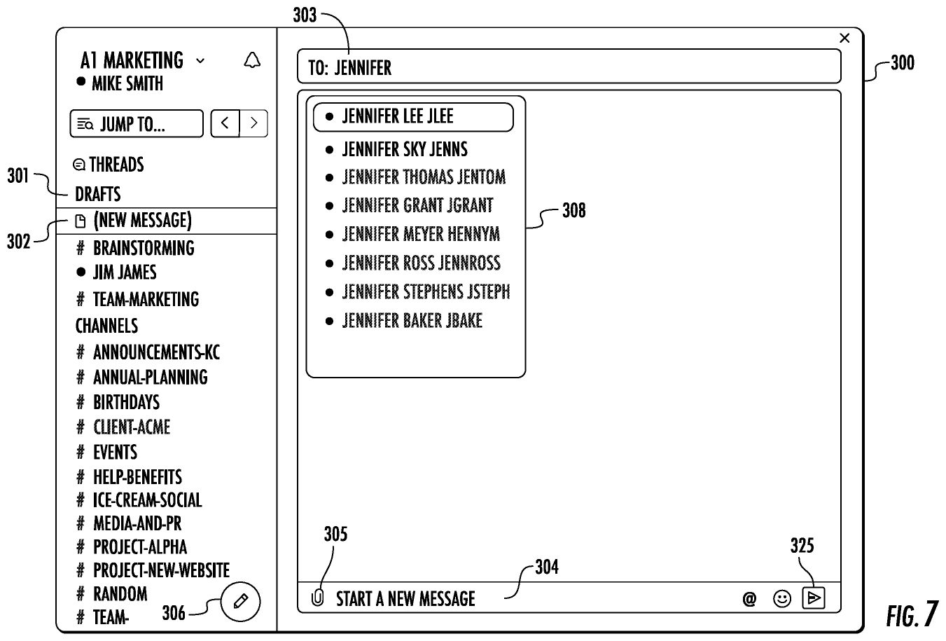

In the exemplary embodiment illustrated in FIG. 7, the detected keystroke engagement of the destination input component 303 comprises an user recipient indicator (i.e., “jennifer”) and, as a result, the determined and depicted second destination suggestions set comprises multiple suggested user recipients. In particular, in response to detecting a first keystroke engagement to the destination input component 303, the draft message circuitry 206 determines a second destination suggestions set by querying the group-based communication suggestions repository based upon at least the user identifier and the detected first keystroke engagement. For purposes of illustration and not of limitation, referring to FIG. 7, in an instance in which the detected first keystroke engagement comprises the phrase “jennifer” which is entered into the destination input component 303 by the user, the draft message circuitry 206 queries the group-based communication suggestions repository for destination suggestion items based upon at least (i.e., associated with) the user identifier received with the compose draft message request and “jennifer.” This results in a second destination suggestions set comprising user identifiers corresponding to user recipients that begin with or otherwise contain “jennifer” and are otherwise associated with the user. In this regard, a number of destination suggestions containing the phrase “jennifer” may be defined by the draft message circuitry 206 as the second destination suggestions set and the destination suggestion interface 308 is automatically updated to replace the first destination suggestions set with such second destination suggestions set.

In some embodiments, the group-based communication apparatus 210 is configured to, through the draft message circuitry 206, base the determination (and/or ranking as discussed below) of potential destination suggestion items on at least one additional data value or data item. That is, in some embodiments, the group-based communication suggestions repository further comprises user profile data such that the group-based communication apparatus 210 is further configured to retrieve user profile data associated with the user identifier from the group-based communication suggestions repository. User profile data may contain various information attributed to or associated with the user, such as user role data, user organization data, user topic data, historical channel interaction data, historical thread interaction data, and/or historical user interaction data associated with the user identifier. For example, user role data may refer to the status of the user within a group-based communication channel, the company associated with the user or group, or other type of role. For example, a user associated with a particular company or organization may comprise roles such as “employee”, “associate”, “supervisor”, “lawyer”, “hr”, and the like. User organization data may refer to an organization or commercial enterprise to which the user is related or employed by (e.g., employees of different companies may be separate organization groups and as such, have separate organization identifiers associated with the user profile). User topic data may refer to conversation topics with which the user is associated. For example, a particular user's messages may be analyzed or parsed to determine a topical context regarding the user (e.g., the user's expertise or interest in a topic may be determined based on the frequency of mention of the topic or key words associated with the topic within such messages). Historical channel interaction data refers to all channels with which a user has interacted. From historical channel interaction data, potential destination suggestion items may be determined based on the frequency or recency with which the particular user has interacted with a particular channel. For example, 5 of the last 7 messages posted by the particular user may have posted to a channel titled “#client-marketing” and the most recent channel to which the particular user posted a message may have been a channel titled “#client-acme.” Based on analysis of this historical channel interaction data and the particular workspace associated with the group identifier, the draft message circuitry 206 may include “#client-marketing” and “#client-acme” as two of the plurality of recommended destination input suggestions in the first destination suggestions set. Similarly, historical thread interaction data refers to all threads with which a user has interacted.

Similarly, historical user interaction data refers to all users with which a particular user has interacted. From historical user interaction data, potential destination suggestions may be determined based on the frequency and/or recency with which the particular user has interacted with other user(s). For example, 3 of the last 5 direct messages sent by the particular user may have been sent to a user associated with the user identifier “Ray Edison” and the most recent direct message received by the particular user may have been associated with a MPDM comprising the particular user, “Ray Edison”, and “Bob Greene”. Based on analysis of this historical user interaction data and the particular workspace associated with the group identifier, the draft message circuitry 206 may include “Ray Edison” and “Ray Edison, Bob Greene” as two of the plurality of recommended destination input suggestions in the first destination suggestions set.

In some embodiments, such destination suggestion items are associated with a particular group identifier associated with the user. For example, in some embodiments, the group-based communication workspace with which the user is currently accessing the system is the current group identifier. As such, the compose draft message request further comprises the current group identifier associated with the group-based communication interface. In particular embodiments, the queried destination suggestion items are culled from user recipient data, group-based communication thread data, and group-based communication channel data stored in the group-based communication suggestions repository and such culled items are restricted to those user recipients, group-based communication threads, and group-based communication channels associated with the current group identifier (the particular group-based communication workspace with which the user is currently interacting). As discussed herein, the user identifier may be associated with a plurality of group-based communication workspaces in addition to the current group identifier, i.e., one or more additional group identifiers. As such, in some embodiments, the destination suggestion items returned by the queries for the first and second destination suggestions set comprise one or more destination suggestion items associated with the one or more additional group identifiers. For example, the user may be accessing the group-based communication system via a group-based communication interface associated with one group-based communication workspace. Rather than requiring the user to close the current group-based communication workspace or interface or switch to a different group-based communication workspace or interface with which the user is associated, the group-based communication apparatus 210 determines and renders a destination suggestions set including destination suggestion items from a plurality of workspaces, not just the current workspace within which the user is accessing the group-based communication system.

In particular embodiments, the group-based communication apparatus 210 is configured to rank the destination suggestion items returned by the query based on the retrieved user profile data and determine the first destination suggestions set based on the ranking of the destination suggestion items. That is, the draft message circuitry 206 is configured to prioritize and/or rank the destination suggestion items. In some embodiments, the group-based communication apparatus 210, via the draft message circuitry 206, assigns scores or weights to the potential destination suggestion items and then use the scored/weighted potential destination suggestion items to determine the destination suggestion items to be included in the first destination suggestions set.

The draft message circuitry 206 may assign scores or weights pursuant to any one of a plurality of methods. For example, in some embodiments, the draft message circuitry 206 is configured to determine and assign a relevancy score based on factors and information in the retrieved user profile data, such as historical channel interaction data or historical thread interaction data. That is, the frequency and recency with which the user has interacted with a group-based communication channel, group-based communication thread, or user recipient can be used to rank or prioritize the destination suggestion items. It should be pointed out that the above scoring of data by the draft message circuitry 206 (e.g., frequency, recency, etc.) are for purposes of illustration and not of limitation and other suitable variations of assigning scores or weighting the potential destination suggestion items are also contemplated by this disclosure as will be apparent to one of ordinary skill in the art.

In some example embodiments, the draft message circuitry 206 may score/weight the destination suggestion items and determine recommended destination suggestion items to include in the first destination suggestions set based in part on comparing a ranking of the destination suggestion item to a predetermined threshold. For example, the destination suggestion interface 308 may be predefined to include or render a predetermined number (e.g., 5) of destination suggestion items. As such, in an example embodiment, the top number (e.g. top 5) of destination suggestion items in the ranking (e.g., destination suggestion items with the top 5 scores) corresponding to the predetermined number (e.g., 5) of destination suggestion items defined for inclusion in the destination suggestion interface 308 may be defined as the first destination suggestions set.

In an alternative example embodiment, the draft message circuitry 206 determines that destination suggestion items having a score above a predetermined threshold (e.g., 0.8) are included in the destination suggestion interface 308 as the first destination suggestions set. In this regard, the first destination suggestions set included in the destination suggestion interface 308 for display may vary between 1 and some upper limit number (e.g., 10, 100) of suggested destination defined to be included in the destination suggestion interface 308.

As discussed above, in some embodiments, the group-based communication apparatus 210 determines the second destination suggestions set by querying the group-based communication suggestions repository based upon at least the user identifier and the detected first keystroke engagement. In still further embodiments, such determination comprises updating the ranking of the destination suggestion items based on the retrieved user profile data and the detected first keystroke engagement to define the second destination suggestions set.

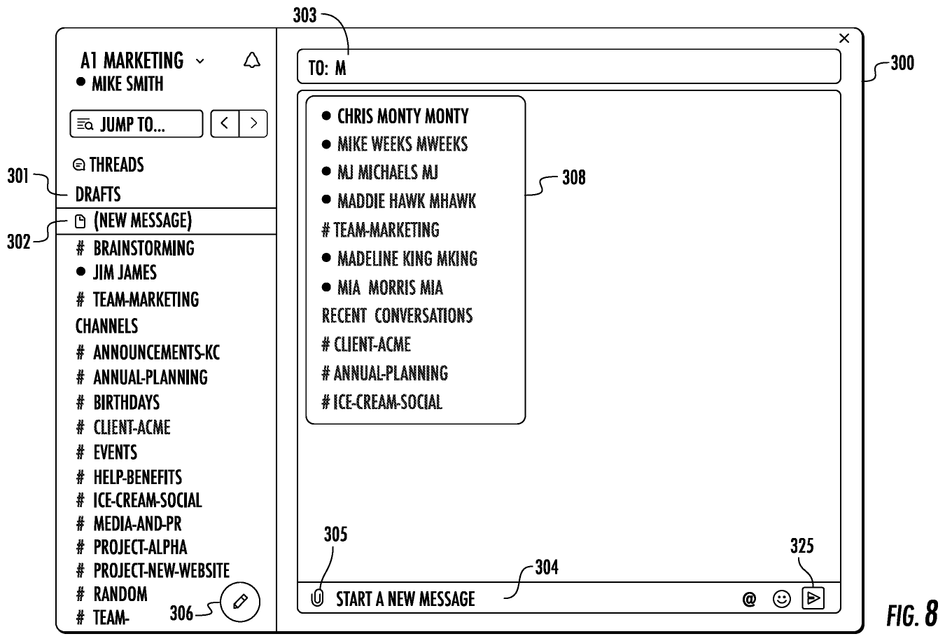

Additionally and/or alternatively, the group-based communication apparatus 210 is configured to further render a set of destination suggestion items comprising the most recent destinations (i.e., conversations) associated with the user identifier, regardless of the detected first keystroke engagement. For example, in addition to defining and rendering the second destination suggestions set, it is contemplated the group-based communication apparatus 210 is configured to append a number of recent destinations with which the user has interacted to the rendering of the second destination suggestion set as depicted in FIG. 8.

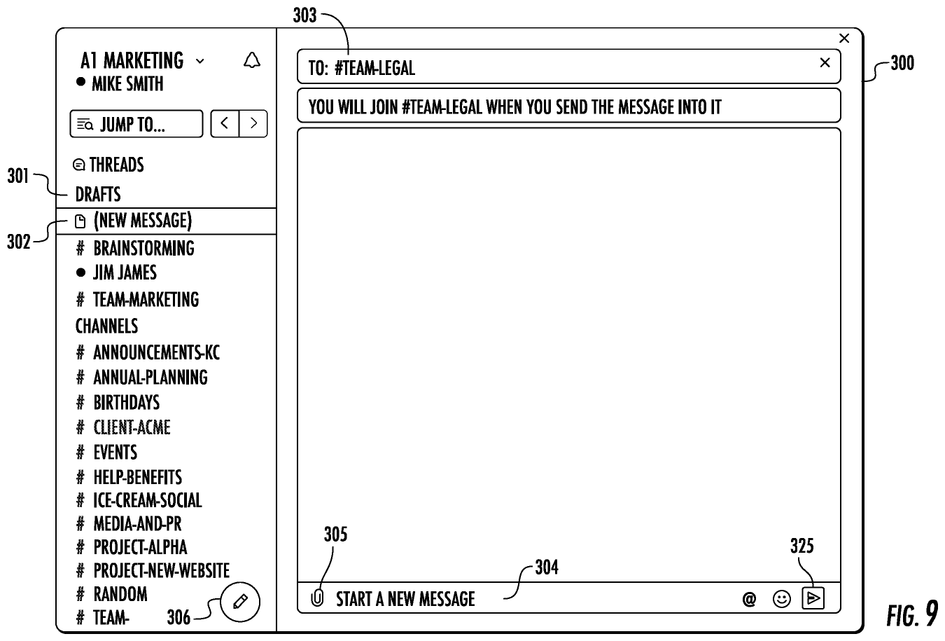

In another example embodiment, the group-based communication apparatus 210 is configured to have workspace awareness. For example, in some embodiments, the suggested destination items include group-based communication channels that the user (i.e., the user identifier or user profile) has the ability to read and see, regardless of the user's ability to send or post messages to such channels. Upon receipt of a group-based communication channel indicator or a first destination selection indicator in the destination input component 303 corresponding to a group-based communication channel, in some embodiments, the group-based communication apparatus 210 is configured to determine whether the selected group-based communication channel is a permitted group-based communication channel. That is, the group-based communication apparatus determines whether the user profile associated with the user identifier is a member of the selected group-based communication channel. In particular embodiments, the group-based communication apparatus determines such membership status by comparing the user identifier to a channel membership directory associated with the selected group-based communication channel. In still further embodiments, the group-based communication apparatus queries the channel membership directory associated with the selected group-based communication channel based at least upon the user identifier. A group-based communication repository 207, e.g., the group-based communication suggestions repository, comprises the channel membership directory in some embodiments. In still further embodiments, the group-based communication apparatus 210 is configured to render an alert message, warning, or indication to the draft message composer interface indicating that the user will join the selected group-based communication channel by posting or sending the draft message, as illustrated in FIG. 9. In other embodiments, the group-based communication apparatus 210 is configured to cause rendering of an error message, warning, or indication to the draft message composer interface 300 that the user is not allowed to post to such selected channel.

In still further embodiments, the group-based communication apparatus 210 is configured to determine whether the user profile associated with the user identifier has write access privileges to the selected group-based communication channel. In an instance whereupon it is determined that the user profile associated with the user identifier has write access privileges to the selected group-based communication channel, the group-based communication apparatus 210 is configured to cause rendering in the destination input component 303 of a channel title tile associated with the selected group-based communication channel. In still further embodiments, the group-based communication apparatus 210 further configures the destination input component 303 to prevent keystroke engagement of the destination input component 303. In some embodiments, determining whether the user profile associated with the user identifier has write access privileges to the selected group-based communication channel comprises retrieving the user profile associated the user identifier from the group-based communication suggestions repository and analyzing the retrieved user profile for access data associated with the selected channel. In an instance whereupon it is determined that the user profile associated with the user identifier does not have write access privileges (i.e., archived channel, announcements only channel, etc.) to the selected group-based communication channel, the group-based communication apparatus 210 is configured to cause rendering of an error indication to the draft message composer interface 300.

Additionally and/or alternatively, upon completion of the selection of a destination, the group-based communication apparatus 210 is configured to query the group-based communication suggestions repository for user preferences associated with the selected destination. That is, in some embodiments, the user has specific user preferences and/or capabilities associated with certain group-based communication channels. For example, although a user is associated with multiple channels, the user has certain additional emojis, templates, etc. associated with a selected group-based communication channel that are not available to all group-based communication channels. Such user preferences may be associated with the group identifier in some embodiments and/or the user identifier in some embodiments, and/or the channel identifier in some embodiments. In an instance where a user has specific user preferences associated with a selected destination, e.g., a selected group-based communication channel, the draft content input component 304 is configured to allow access to such user preferences, i.e., render emojis, templates, etc.

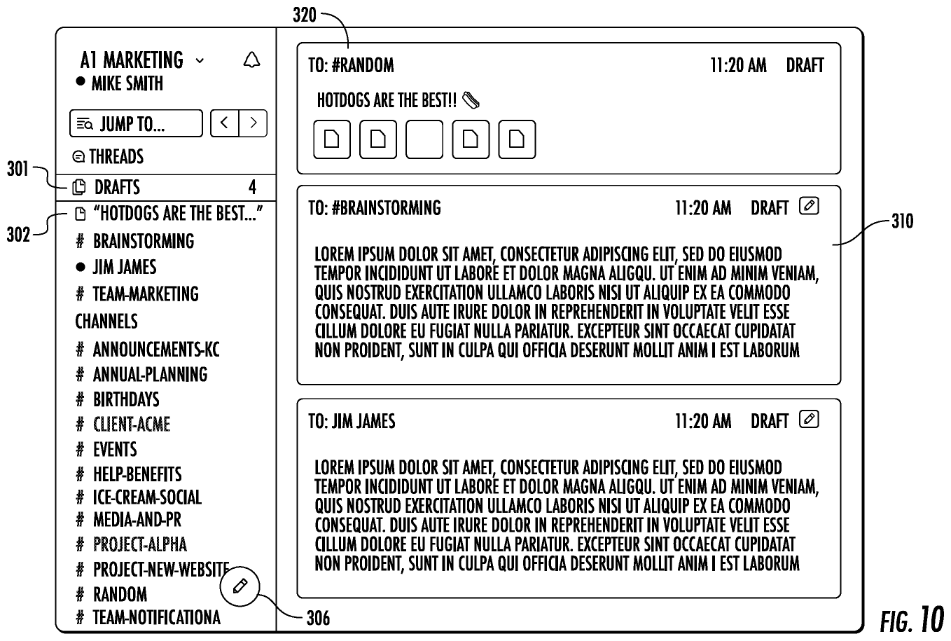

In various embodiments of the present disclosure, the group-based communication apparatus 210 is configured to manage a drafts view interface of a group-based communication system. In such embodiments, the group-based communication apparatus 210 is configured to receive a drafts view request comprising a user identifier. In some embodiments, the group-based communication apparatus 210 is configured to, in response to receiving a drafts view request comprising a user identifier, query a group-based communication repository for all draft messaging communications associated with the user identifier and cause rendering to a drafts view interface of all draft messaging communications returned by the query. In some embodiments, the group-based communication repository is the group-based communication drafts repository. FIG. 10 depicts an example drafts view interface 320 structured in accordance with various embodiments of the invention. The dimension of the drafts view interface 320 in FIG. 10 is depicted as full-screen, fitting to the size of the group-based communication interface subject to the sidebar pane (i.e., filling the message pane), however, such depiction is for purposes of illustration and not of limitation and other suitable variations of the dimension of the drafts view interface 320, such as a modal interface, are also contemplated by this disclosure as will be apparent to one of ordinary skill in the art.

The depicted drafts view interface 320 is rendered in response to receipt of the drafts view request. In some embodiments, the drafts view interface 320 is revealed and/or accessed once a user clicks on a “Drafts” interface element corresponding to the drafts section 301 of a sidebar pane of a group-based communications interface as depicted in FIG. 10. Such depiction is for purposes of illustration and not of limitation and other suitable variations of accessing the drafts view interface 320 are also contemplated by this disclosure as will be apparent to one of ordinary skill in the art.

The group-based communication apparatus 210 is configured to query the group-based communication drafts repository for all draft messaging communications associated with the user identifier. In some instances, the user identifier is associated with an author identifier, indicating that such draft messaging communications are authored by a particular user (e.g., created by a client device associated with the particular user, user identifier, or user profile). As such, each of the draft messaging communications returned by the query comprise an author identifier matching the user identifier. In other embodiments, identifying and accessing one or more draft messaging communication comprises querying all client devices associated with the user identifier for all draft messaging communications associated with the user identifier.

In some embodiments, the querying and culling of the draft messaging communications associated with the user identifier is not limited to draft messaging communications that originate from the draft message composer interface 300. That is, draft messaging communications can originate from use of the draft message composer interface 300 or from the use of the message interface component of a group-based communication channel interface, a group-based communication thread interface, or a direct message conversation interface. Those draft messaging communications originating from the draft message composer interface 300 are “unattached” or “inactive” such that they are not considered to be associated with a specific channel, thread, or user recipient(s). Even upon keystroke entry in the destination input component 303 or selection of a destination suggestion item in the destination suggestion interface 308, such draft messaging communications are considered “unattached” or “inactive.” In some embodiments, a user is capable of having a plurality of draft messaging communications associated with its user profile and/or user identifier. Draft messaging communications that originate from the use of the message interface component of a channel interface, thread interface, or direct message conversation interface are “attached,” and in some embodiments, a user is limited to only one attached draft messaging communication per channel, thread, or direct message conversation. In some embodiments, regardless of the origination source of the draft messaging communication, the group-based communication apparatus 210 is configured to query the group-based communication drafts repository and cause rendering of all draft messaging communications returned by the query, regardless of source. In other embodiments, the group-based communication apparatus 210 is configured to query the group-based communication drafts repository and cause rendering of only those draft messaging communications that originate from use of the draft message composer interface 300.

Upon return of the draft messaging communications by the query, the draft message circuitry 206 may cause ordering of the draft messaging communications within the drafts view interface 320 in a myriad of ways. In one embodiment, the draft message circuitry 206 orders the display of the draft messaging communications based on the alphabetical sequence of the draft message titles of the draft messaging communication. In other embodiments, the display of the draft messaging communications is ordered based on the type of the draft messaging communication. For example, all draft messaging communications associated with group-based communication channels are grouped together, all draft messaging communication associated with group-based communication threads are grouped together, and all draft messaging communications associated with direct message conversations are grouped together. In other embodiments, the display of the draft messaging communications is ordered based on the origination source of the draft messaging communication. For example, all draft messaging communications originating from a draft message composer interface 300 are grouped together and all draft messaging communications originating from a group-based communication channel, a group-based communication thread, or a direct message conversation feed are grouped together. In other embodiments, the display of the draft messaging communications is ordered based on the last edit timestamp. For example, in some instances, the draft messaging communications are ordered chronologically based on the last edit timestamp In other instances, the draft messaging communications are ordered reverse chronologically based on the last edit timestamp. Other variations of ordering the draft messaging communications in the drafts view interface 320 are also contemplated by this disclosure as will be apparent to one of ordinary skill in the art.

In some embodiments, the rendering of each draft messaging communications to the drafts view interface 320 comprises a user engageable link configured to allow access to the draft messaging communication upon user selection engagement of the user engageable link selected draft messaging communication. In further embodiments, the user engageable link is configured to allow access to and cause rendering of the selected draft messaging communication in a draft message composer interface 300, as discussed in detail above. In still further embodiments, the user engageable links is configured to allow access to and cause rendering of the selected draft messaging communication in a group-based communication channel interface, a group-based communication thread interface, or a direct message interface. For example, in those embodiments in which the group-based communication apparatus 210 is configured to cull all draft messaging communications associated with a user identifier, regardless of source, the user engageable link of an “attached” draft messaging communication allows access to the selected draft messaging communication in a group-based communication channel interface, a group-based communication thread, or a direct message interface, while the user engageable link of an “unattached” draft messaging communication allows access to the selected draft messaging communication in the draft message composer interface 300.

### Example Operations Performed By the Apparatuses

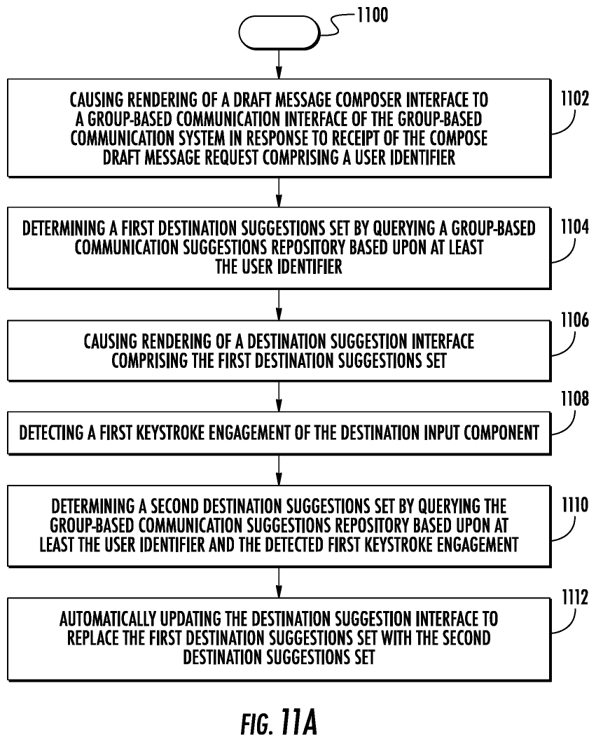

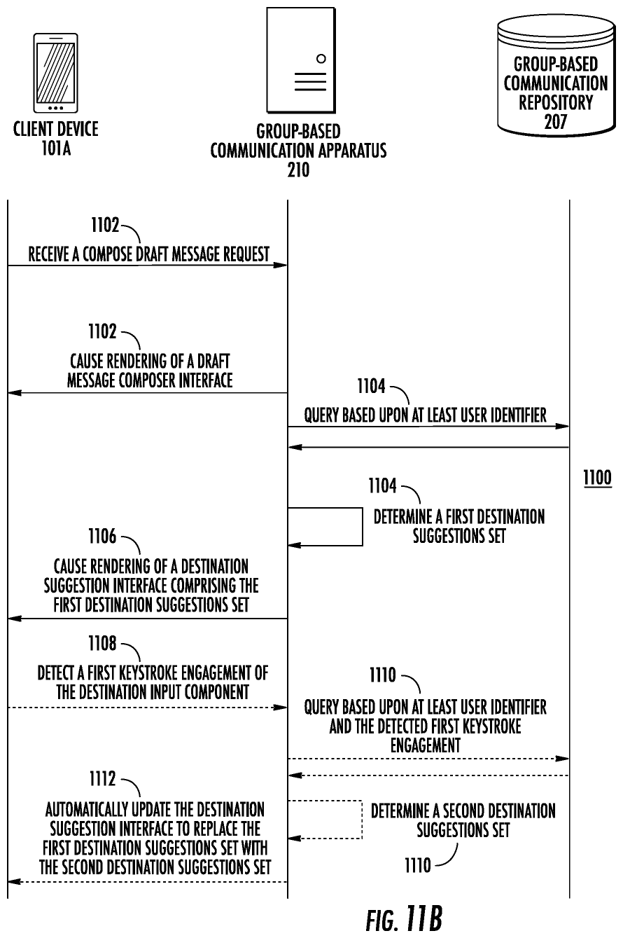

Having described the group-based communication apparatus and exemplary circuitry comprising embodiments of the present disclosure, it should be understood that the group-based communication apparatus 210 may proceed to manage draft messaging communications and associated draft messaging interfaces of a group-based communication system in a number of ways. FIG. 11A is a flowchart broadly illustrating a series of operations or process blocks that are executed or performed to determine and render a first destination suggestions set in a group-based communication system in accordance with one embodiment of the present disclosure. The operations illustrated in FIG. 11A may, for example, be performed with the assistance of, and/or under the control of group-based communication apparatus 210.

In the embodiment illustrated in FIG. 11A, the flowchart illustrates method 1100 which includes causing rendering of a draft message composer interface to a group-based communication interface of the group-based communication system in response to receipt of a compose draft message request comprising a user identifier at Block 1102. For example, a group-based communication apparatus may include means, such as the processor 202, draft message circuitry 206, input/output circuitry 203, or the like, for receiving the compose draft message requests and causing such rendering. A draft message composer interface 300 comprising a destination input component 303 and a draft content input component 304 as shown in FIG. 3A is one example of such rendering to the group-based communication interface.

In some embodiments, at Block 1104, the method 1100 further includes determining a first destination suggestions set by querying a group-based communication suggestions repository based upon at least the user identifier. In some embodiments, the first destination suggestions set comprises one or more suggested user recipients, one or more suggested group-communication threads, one or more suggested group-based communication channels, or combinations thereof. In still other embodiments, determining the first destination suggestions set comprises querying the group-based communication suggestions repository for destination suggestion items, retrieving user profile data associated with the user identifier from the group-based communication suggestions repository, ranking the destination suggestion items returned by the query based on the retrieved user profile data, and determining the first destination suggestions set based on the ranking of the destination suggestion items. As discussed in more detail above, the user profile data may comprise user role data, user organization data, user topic data, historical channel interaction data, historical thread interaction data, historical user interaction data associated with the user identifier, or combinations thereof.

At Bock 1106, the method 1100 further includes causing rendering of a destination suggestion interface comprising the first destination suggestions set. The plurality of destination suggestion items in the first destination suggestions set may be organized alphabetically, by ranking, or by some other appropriate method as disclosed herein.

In some embodiments, the method 1100 may include detecting a first keystroke engagement of the destination input component of the draft message composer interface at Block 1108. In some embodiments, the detected first keystroke engagement comprises a group-based communication channel indicator, such as a keystroke entry of a hashtag.

In still further embodiments, the method 1100 may also include determining a second destination suggestions set by querying the group-based communication suggestions repository based upon at least the user identifier and the detected first keystroke engagement as in Block 1110. In some embodiments, the method 1100 further includes automatically updating the destination suggestion interface to replace the destination suggestions set with the second destination suggestions set at Block 1112.

FIG. 11B is a signal diagram of an example data flow represented by method 1100. That is, FIG. 11B illustrates an example signal diagram illustrating data flow interactions between a group-based communication apparatus, a group-based communication repository (i.e., group-based communication suggestions repository), and one or more client devices when managing a draft message composer interface in accordance with one embodiment. Method 1100 is described as being performed by a client device 101A, a group-based communication apparatus 210, and a group-based communication repository 207. These may be similar to those previously discussed with regards to FIG. 1.

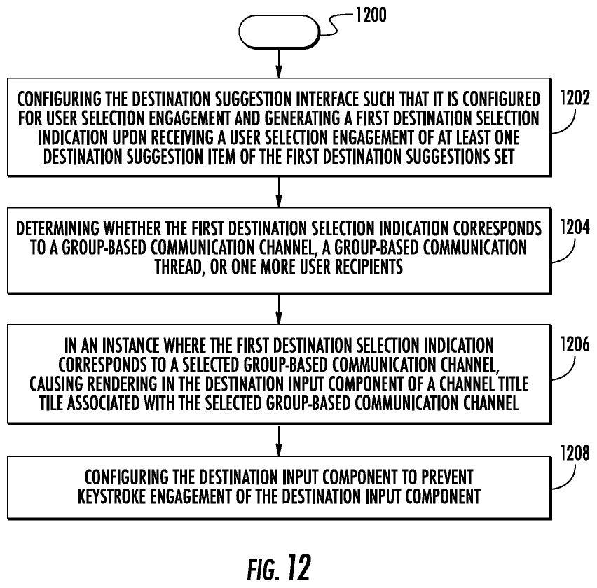

FIG. 12 is a flowchart illustrating operations that are executed by an exemplary group-based communication apparatus for managing a draft message composer interface of a group-based communication system according to one embodiment of the present disclosure. In the embodiment illustrated in FIG. 12, the flowchart illustrates method 1200 which includes configuring the destination suggestion interface such that it is configured for user selection engagement and generating a first destination selection indication upon receiving a user selection engagement of at least one destination suggestion item of the first destination suggestions set at Block 1202. Additionally, the method 1200 includes in response to receiving the first destination selection indication, determining whether the first destination selection indication corresponds to a group-based communication channel, a group-based communication thread, or one or more user recipients at Block 1204. In an instance where the first destination selection indication corresponds to a selected group-based communication channel, at Block 1206, the method 1200 comprises causing rendering in the destination input component of a channel title tile associated with the selected group-based communication channel. At Block 1208, the method 1200 may also include configuring the destination input component to prevent keystroke engagement of the destination input component.

Although not demonstrated in FIG. 12, in an instance wherein it is determined that the first destination selection indication corresponds to a selected group-based communication thread, the method 1200 may further include causing rendering in the destination input component of a thread title tile associated with the selected group-based communication thread and optionally configuring the destination input component to prevent keystroke engagement of the destination input component, similar to the depicted Blocks 1206 and 1208. In an instance wherein it is determined that the first destination selection indication corresponds to one or more user recipients, the method 1200 may further include causing rendering in the destination input component of a user identifier associated with each user recipient of the one or more selected user recipients, configuring the destination input component to facilitate a keystroke engagement of the destination input component corresponding to one or more additional selected user recipients, determining an additional user recipient suggestions set; and automatically updating the destination suggestion interface to replace the first destination suggestions set with the additional user recipient suggestions set. In some embodiments, determining the additional user recipient suggestions set is based upon at least the user identifier and the first destination selection indication as explained in more detail above. Such determining step may comprise querying the group-based communication suggestions repository with such parameters.

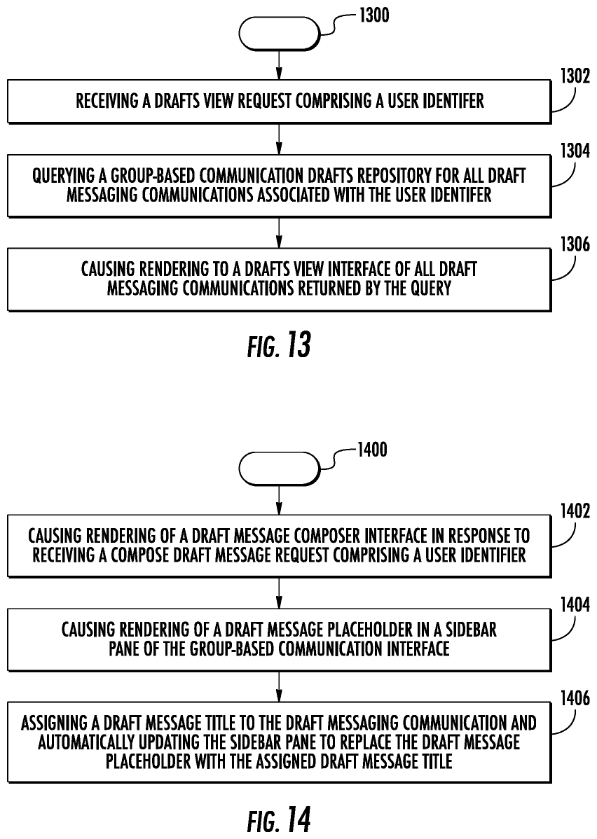

FIG. 13 is a flowchart illustrating operations that are executed by an exemplary group-based communication apparatus for managing a drafts view interface of a group-based communication system according to one embodiment of the present disclosure. In the embodiment illustrated in FIG. 13, the flowchart illustrates method 1300 which includes receiving a drafts view request comprising a user identifier at Block 1302 and querying a group-based communication drafts repository for all draft messaging communications associated with the user identifier at Block 1304. The method 1300 further includes causing rendering of a drafts view interface of all draft messaging communications returned by the query at Block 1306. In some embodiments, the rendering of the draft messaging communications to the drafts view interface is based on a last edit timestamp. In still further embodiments, the rendering of each of the one or more draft messaging communications to the drafts view interface comprises a user engageable link to allow access to the selected draft messaging communication.

FIG. 14 is a flowchart illustrating operations that are executed by an exemplary group-based communication apparatus for managing a group-based communication interface of a group-based communication system according to one embodiment of the present disclosure. In the embodiment illustrated in FIG. 14, the flowchart illustrates method 1400 which includes receiving a compose draft message request comprising a user identifier and causing rendering of a draft message composer interface to the group-based communication interface of the group-based communication system in response to receipt of the compose draft message request at Block 1402. The method 1400 further includes causing rendering of a draft message placeholder in a sidebar pane of the group-based communication interface at Block 1404. The draft message placeholder is associated with a draft messaging communication associated with the draft message composer interface.

At Block 1406, the method 1400 may also include assigning a draft message title to the draft messaging communication and automatically updating the sidebar pane of the group-based communication interface to replace the draft message placeholder with the assigned draft message title. In some embodiments, assigning the draft message title to the draft messaging communication comprises detecting a keystroke engagement of a draft content input component of the draft message composer interface and assigning at least a portion of the detected keystroke engagement as the draft message title of the draft messaging communication. In other embodiments, assigning the draft message title to the draft messaging communication comprises detecting a keystroke engagement in a destination input component of the draft message composer interface and assigning at least a portion of the detected keystroke engagement as the draft message title of the draft messaging communication.

### Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A group-based communication apparatus configured to manage a draft message composer interface of a group-based communication system, the group-based communication apparatus comprising at least one processor and at least one memory, the at least one memory having computer-coded instructions therein, wherein the computer-coded instructions are configured to, in execution with the at least one processor, cause the group-based communication apparatus to:
cause rendering of a draft message composer interface to a group-based communication interface of the group-based communication system in response to receiving a compose draft message request comprising a user identifier, wherein the draft message composer interface comprises a destination input component;
in response to detecting a non-keystroke engagement of the destination input component, determine a first destination suggestions set by querying a group-based communication suggestions repository based upon at least the user identifier; and
cause rendering of a destination suggestion interface comprising the first destination suggestions set.

2. The group-based communication apparatus of claim 1, wherein the computer-coded instructions are further configured to cause the group-based communication apparatus to:
detect a first keystroke engagement of the destination input component;
determine a second destination suggestions set by querying the group-based communication suggestions repository based upon at least the user identifier and the detected first keystroke engagement; and
automatically update the destination suggestion interface to replace the first destination suggestions set with the second destination suggestions set.

3. (canceled)

4. The group-based communication apparatus of claim 1, wherein the first destination suggestions set comprises one or more suggested user recipients, one or more suggested group-based communication threads, one or more suggested group-based communication channels, or combinations thereof.

5. (canceled)

6. (canceled)

7. The group-based communication apparatus of claim 1, wherein the destination suggestion interface is configured for user selection engagement, and wherein a first destination selection indication is generated upon user selection engagement of at least one destination suggestion item of the first destination suggestions set.

8. The group-based communication apparatus of claim 7, wherein the computer-coded instructions are further configured to cause the group-based communication apparatus to:
in response to generating a first destination selection indication upon user selection engagement of at least one destination suggestion item, determine whether the first destination selection indication corresponds to a group-based communication channel, a group-based communication thread, or one or more user recipients; and
in an instance where the first destination selection indication corresponds to a selected group-based communication channel, cause rendering in the destination input component of a channel title tile associated with the selected group-based communication channel.

9. (canceled)

10. The group-based communication apparatus of claim 8, wherein the channel title tile comprises a user engageable deletion element and the computer-coded instructions are further configured to stop rendering the channel title tile to the destination input component upon detection of a user selection engagement of the user engageable deletion element.

11. The group-based communication apparatus of claim 8, wherein the computer-coded instructions are further configured to cause the group-based communication apparatus to configure the destination input component to facilitate a keystroke engagement of the destination input component corresponding to one or more additional group-based communication channels; and
in response to receipt of one or more keystrokes corresponding to one or more additional group-based communication channels, cause rendering of an alert message to the draft message composer interface.

12.-14. (canceled)

15. The group-based communication apparatus of claim 8, wherein the computer-coded instructions are further configured to cause the group-based communication apparatus to:
in an instance where the first destination selection indication corresponds to one or more selected user recipients, cause rendering in the destination input component of a user identifier tile associated with each user recipient of the one or more selected user recipients;
configure the destination input component to facilitate a keystroke engagement of the destination input component corresponding to one or more additional selected user recipients;
determine an additional user recipient suggestions set; and
automatically update the destination suggestion interface to replace the first destination suggestions set with the additional user recipient suggestions set.

16. (canceled)

17. The group-based communication apparatus of claim 15, wherein each user identifier tile comprises a user engageable deletion element and the computer-coded instructions are further configured to stop rendering at least one of the user identifier tiles to the destination input component upon detection of a user selection engagement of at least one of the user engageable deletion elements.

18. The group-based communication apparatus of claim 1, wherein determining the first destination suggestions set by querying the group-based communication suggestions repository based upon at least the user identifier comprises:
querying the group-based communication suggestions repository for destination suggestion items;
retrieving user profile data associated with the user identifier from the group-based communication suggestions repository;
ranking the destination suggestion items returned by the query based on the retrieved user profile data; and
determining the first destination suggestions set based on the ranking of the destination suggestion items.

19. The group-based communication apparatus of claim 18, wherein the user profile data stored in the group-based communication suggestions repository comprises at least one of user role data, user organization data, user topic data, historical channel interaction data, historical thread interaction data, historical user interaction data, or combinations thereof.

20. The group-based communication apparatus of claim 18, wherein the compose draft message request further comprises a current group identifier associated with the group-based communication interface and the retrieved user profile data comprises one or more additional group identifiers associated with the user identifier.

21. The group-based communication apparatus of claim 20, wherein the destination suggestion items returned by the query comprise one or more destination suggestion items associated with the current group identifier.

22. The group-based communication apparatus of claim 20, wherein the destination suggestion items returned by the query comprise one or more destination suggestion items associated with the one or more additional group identifiers.

23.-28. (canceled)

29. The group-based communication apparatus of claim 7, wherein the first destination selection indication corresponds to a selected group-based communication channel wherein the computer-coded instructions are further configured to cause the group-based communication apparatus to:
determine whether the user profile associated with the user identifier is a member of the selected group-based communication channel; and
in an instance where the user profile associated with the user identifier is not a member of the selected group-based communication channel, cause rendering of an alert message to the draft message composer interface.

30. (canceled)

31. The group-based communication apparatus of claim 29, wherein the computer-coded instructions are further configured to cause the group-based communication apparatus to:
in an instance where the user profile associated with the user identifier is a member of the selected group-based communication channel, determine whether the user profile associated with the user identifier has write access privileges to the selected group-based communication channel; and
in an instance where the user profile associated with the user identifier has write access privileges to the selected group-based communication channel, cause rendering in the destination input component of a channel title tile associated with the selected group-based communication channel.

32. (canceled)

33. The group-based communication apparatus of claim 31, wherein the channel title tile comprises a user engageable deletion element and the computer-coded instructions are further configured to stop rendering the channel title tile to the destination input component upon detection of a user selection engagement of the user engageable deletion element.

34. The group-based communication apparatus of claim 31, wherein the computer-coded instructions are further configured to cause the group-based communication apparatus to:
in an instance where the user profile associated with the user identifier does not have write access privileges to the selected group-based communication channel, cause rendering of an error indication to the draft message composer interface.

35. (canceled)

36. A group-based communication apparatus configured to manage a drafts view interface of a group-based communication system, the group-based communication apparatus comprising at least one processor and at least one memory, the at least one memory having computer-coded instructions therein, wherein the computer-coded instructions are configured to, in execution with the at least one processor, cause the group-based communication apparatus to:
in response to receiving a drafts view request comprising a user identifier, query a group-based communication drafts repository for all draft messaging communications associated with the user identifier; and
cause rendering to a drafts view interface of all draft messaging communications returned by the query.

37.-39. (canceled)

40. The group-based communication apparatus of claim 36, wherein each draft messaging communication comprises a user engageable link configured to allow access to the draft messaging communication upon user selection engagement of the user engageable link.

41. The group-based communication apparatus of claim 40, wherein the computer-coded instructions are further configured to cause the group-based communication apparatus to, in response to detecting user selection engagement of the user engageable link, cause rendering of the selected draft messaging communication in a draft message composer interface.

42.-100. (canceled)

101. A computer-implemented method for managing a group-based communication interface of a group-based communication system, the computer-implemented method comprising:
rendering a draft message composer interface to the group-based communication interface of the group-based communication system in response to receiving a compose draft message request comprising a user identifier, wherein the draft message composer interface is associated with a draft messaging communication; and
rendering a draft message placeholder in a sidebar pane of the group-based communication interface, wherein the draft message placeholder is associated with the draft messaging communication.

102. The computer-implemented method of claim 101, further comprising:
assigning a draft message title to the draft messaging communication; and
automatically updating the sidebar pane of the group-based communication interface to replace the draft message placeholder with the assigned draft message title.

103. The computer-implemented method of claim 101, wherein the draft message composer interface comprises a destination input component and a draft content input component.

104. The computer-implemented method of claim 103, wherein assigning the draft message title to the draft messaging communication comprises detecting a keystroke engagement of the draft content input component and assigning at least a portion of the detected keystroke engagement as the draft message title of the draft messaging communication.

105. (canceled)

106. The computer-implemented method of claim 101, wherein the draft message placeholder in the sidebar pane comprises a user engageable link configured to allow access to the draft messaging communication upon user selection engagement of the user engageable link.

107. The computer-implemented method of claim 102, wherein the draft message title in the sidebar pane comprises a user engageable link configured to allow access to the draft messaging communication upon user selection engagement of the user engageable link.
